(19) United States
(12) Patent Application Publication
(10) Pub. No.: US 2009/0042169 A1
(43) Pub. Date: Feb. 12, 2009

(54) PREDOMINANTLY PLATELET-SHAPED, SPARINGLY WATER-SOLUBLE CALCIUM SALTS AND/OR COMPOSITE MATERIALS THEREOF COMPRISING THEM

(76) Inventors: Lothar KINTRUP, Dusseldorf (DE); Burkhard ESCHEN, Neuss (DE); Martina HERMANN, Dusseldorf (DE); Holger FRANKE, Ginsheim-Gustavsburg (DE)

Correspondence Address: PAUL & PAUL, 2000 MARKET STREET, Suite 2900, PHILADELPHIA, PA, 19103-3229, US

(21) Appl. No.: 12/241,718

(22) Filed: Sep. 30, 2008

Related U.S. Application Data
(63) Continuation of application No. PCT/EP2006/010235, filed on Oct. 24, 2006.

(30) Foreign Application Priority Data
Mar. 1, 2006 (DE) 10 2006 009 799.8

(51) Int. Cl. A61C 17/00; A61C 5/00

(52) U.S. Cl. 433/217.1; 106/35; 523/115

(57) ABSTRACT

The invention relates to sparingly water-soluble calcium salts and/or composite materials comprising them, characterized in that the calcium salts are present in the form of single crystals or in the form of particles comprising a multitude of said crystals and having a mean particle diameter in the region of below 1,000 nm, preferably below 300 nm, the calcium salt particles being predominantly platelet-like. The inventive calcium salts and/or composite materials comprising these calcium salts, owing to their composition and fine structure, are particularly suitable for promoting the restoration of bone and tooth material, especially enamel and dentine.

### CROSS-REFERENCE TO RELATED APPLICATIONS

This application is a continuation under 35 U.S.C. Sections 365(c) and 120 of International Application No. PCT/EP2006/010235, filed Oct. 24, 2006. This application also claims priority under 35 U.S.C. Section 119 of German Patent Application No. DE 10 2006 009 799.8, filed Mar. 1, 2006.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The invention concerns sparingly water-soluble calcium salts and/or composite materials thereof comprising them, in which the calcium salts are in the form of individual crystallites or of particles comprising a multiplicity of said crystallites, having a mean particle diameter in the range of less than 1,000 nm, preferably less than 300 nm, and in which the calcium salt particles are predominantly platelet-like. The calcium salts according to the invention and/or composite materials comprising these calcium salts are particularly suitable for promoting restoration of bone and tooth material, especially enamel and dentine, because of their composition and fine structure.

Phosphate salts of calcium have long been added to formulations of tooth cleaning and dental care materials both as abrasive components and for promoting remineralization of dental enamel. That is particularly the case for hydroxyapatite and fluoroapatite as well as for amorphous calcium phosphates and for brushite (dicalcium phosphate dihydrate). Calcium fluoride has been described often as a component of tooth cleaning agents and as a component to harden dental enamel and to prevent tooth decay.

The availability of calcium compounds for the desired remineralization depends quite critically on the particle sizes of these components that are sparingly soluble in water and dispersed in the dental care materials. It has, therefore, been suggested that these sparingly soluble calcium salts be used at extremely fine particle sizes.

The dental enamel and the supporting tissue of the bones are composed predominantly of the material hydroxyapatite. In the process of its biological formation, hydroxyapatite is layered in an ordered manner in the protein matrix of the bone or tooth, which consists primarily of collagen. Thus the development of the hard load-bearing mineral structure is controlled by the “matrix proteins,” which are made up of collagen an other proteins that adhere to the collagen and so provide a structured mineralization process that is also known as biomineralization.

Bone material is a combination of scleroproteins and platelet-like hydroxyapatite.

(2) Description of Related Art, Including Information Disclosed Under 37 C.F.R. Sections 1.97 and 1.98

Substances called “bone replacements,” which promote the natural remineralization process, play an important part in restoration of bone material. Such substances are also required for coating implants in order to achieve integral bonds between the bone and the implant, that can transfer even tensile forces. Coatings with high bioactivity, which produce effective osteogenesis at the bond, are particularly important here. In the state of the art, as is described, for example, by B. G. Willmann in Mat.-Wiss. u. Werkstofftech. 30 (1999) 317, hydroxyapatite is generally applied to implants. The disadvantages of this procedure are the often insufficient acceleration of the biomineralization process, flaking off of the hydroxyapatite layers, and their unsatisfactory chemical stability.

Bone replacement materials that can be applied in liquid form are needed for certain applications. However, those applications cannot be achieved in a satisfactory manner with the usual bone replacement materials. Beyond the disadvantages for applications technology (inadequate dispersibility of the solid components), the bone replacement materials available to date which can be applied in liquid form have at best a biocompatible, perhaps absorbable effect, because of the coarsely crystalline inorganic components and the lack of organic components that are similar to the biological ones. However, what is desired is natural biomineralization and, thus, osteoinductive, osteoconductive or osteostimulating materials that directly promote bone growth.

Among the bone replacement materials, composites of hydroxyapatite and collagen are of particular interest because they resemble the composition of the natural bone. A similar situation prevails for reconstruction of tooth material: dentine consists of about 30% protein (essentially collagen) and 70% mineral substances (essentially hydroxyapatite). Enamel, in contrast, is made up of about 95% hydroxyapatite and 5% proteins.

Composite materials of the type described are accessible synthetically, such as described by B., Flautre et al. in J. Mater. Sci.: Mater. In Medicine 7 (1996) 63. However, in those composites, the particle sizes of the calcium salts are greater than 1,000 nm. That is too large to give a satisfactory biological action as a remineralization agent.

On the other hand, R. Z. Wang et al., J. Mater. Sci. Lett. 14 (1995) 49, describe a process for preparing a composite material of hydroxyapatite and collagen, in which hydroxyapatite is deposited on the collagen matrix in an evenly distributed form with a particle size range of 2 to 10 nm. The composite material is said to have better biological activity than other hydroxyapatite-collagen composites known in the state of the art because of the fine dispersion of the hydroxyapatite. However, as described in the following, the composite material described by R. Z. Wang et al. does not satisfactorily meet the need for composite materials that simulate the composition and microstructure of natural bone and tooth material and are suitable for remineralization of these natural materials in a completely satisfactory manner.

EP 1 139 995 A1 suggests stabilizing suspensions of calcium salts that are sparingly soluble in water in finely divided form during their precipitation or shortly thereafter, by performing the precipitation in the presence of an agglomeration inhibitor or by redispersing the dispersion in the presence of an agglomeration inhibitor, such as a protective colloid or surfactant.

WO 01/01930 discloses composite materials made up sparingly soluble nanoparticulate calcium salts and protein components which have remineralizing action on enamel and dentine. Type A or B gelatins are used for the purpose.

The documents cited do not describe calcium salts or composite materials comprising them which have a predominantly platelet-like structure, exhibit strong mineralizing effects, and so produce particularly effective improvement of dental health even at short exposure times.

A further disadvantage of the protein-containing composite materials known in the state of the art is that they are often expensive to produce. In the production of the composite of hydroxyapatite and collagen described by R. Z. Wang et al., it is necessary to handle insoluble collagen and to distribute it in quite large volumes of solvent. That is technologically expensive. This process also raises additional problems with respect to disposal of the wastewaters arising from the production.

### BRIEF SUMMARY OF THE INVENTION

It has now been found that certain materials are suitable for overcoming the above-mentioned disadvantages of the state of the art.

Surprisingly, it has been possible to prepare calcium salts or composite materials comprising them which have the sparingly water-soluble calcium salts in a predominantly platelet-like structure.

### BRIEF DESCRIPTION OF THE DRAWING

FIG. 1: TEM photograph of the platelet-like composite material prepared according to Example 2.1. Magnification at the instrument: 100,000×.

### DETAILED DESCRIPTION OF THE INVENTION

The invention concerns sparingly water-soluble calcium salts and/or composite materials thereof comprising them, in which the calcium salts are in the form of individual crystallites or of particles comprising a multiplicity of said crystallites, having a mean particle diameter in the range of less than 1,000 nm, preferably less than 300 nm, and in which the calcium salt particles are predominantly rod-like or platelet-like, preferably predominantly platelet-like. The particles of the calcium salts, made up of individual crystallites according to the invention, can be of platelet or rod shape, depending on the conditions of the production process.

The term “predominantly platelet-like” means that at least 50%, preferably at least 70%, and especially preferably at least 80% of the particles are in the form of platelets.

It is particularly preferable for the particles to be of essentially platelet-like form.

It is advantageous for the calcium salts or composite materials comprising them to be particularly similar to the predominantly platelet-like calcium particles in the structure of the bone substance in vivo, which is also made up of platelets. That has the particular advantage that they exhibit particularly good remineralizing and neomineralizing ability because of the similarity to the shape of the biological apatites (such as bone or dentine apatite), so that the process of biomineralization can occur even faster and better.

A further advantage of the invention is that the sparingly water-soluble calcium salts or composite materials comprising them show improved biocompatibility with the predominantly platelet-like structure of the calcium salts.

“Particle diameter” means, here, the diameter of the particles (crystallites or particles) in the direction of their greatest longitudinal extent. The “mean particle diameter” is understood to be the value averaged over the total amount of the composite. According to the invention, it is less than 1,000 nm, preferably less than 300 nm.

It is preferable for the mean particle diameter of the crystallites to be in the range of 10 to 150 nm, and particularly preferable for the crystallites to have a thickness in the range of 2 to 50 nm and a length in the range of 10 to 150 nm. Here, “thickness” is understood to be the smallest diameter of the crystallites, while “length” is their greatest diameter.

The particle diameters of the crystallites can be determined by current methods known to those skilled in the art, especially by the broadening of the reflections observed in x-ray diffraction. The evaluation is preferably done by a fitting procedure such as the Rietveld method.

In a particularly preferred embodiment, the crystallites preferably have a thickness of 2 to 15 nm and a length of 10 to 50 nm. A thickness of 3 to 11 nm and a length of 15 to 25 nm are particularly preferred.

According to a further preferred embodiment of the invention, the inventive calcium salts and/or the composite materials comprising them have a mean particle diameter in the range of less than 1,000 nm, preferably less than 300 nm.

The particle diameters of the particles can be determined by current methods known to those skilled in the art, especially by evaluating imaging processes, especially by transmission electron microscopy.

According to one particular embodiment the sparingly water-soluble calcium salts and/or composite materials comprising them have platelet-like particles with a width in the range of 5 to 150 nm and a length in the range of 10 to 150 nm as well as a height (thickness) of 2 to 50 nm.

Here the height (thickness) is understood to be the smallest diameter of the particle with respect to the three mutually perpendicular spatial directions, and the length is the greatest diameter. The width of the particle is accordingly the other diameter perpendicular to the length, which is equal to or less than the longitudinal dimension of the particle, but greater than or at least equal to its height dimension.

The platelet-like particles are more or less irregularly shaped particles, some of which are rather round particles and some are rather angular particles with rounded edges.

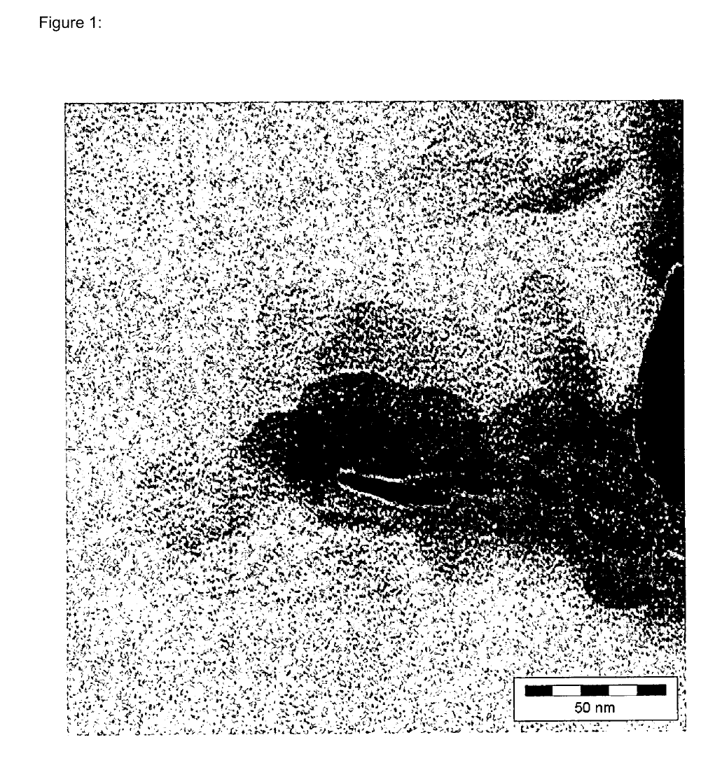

This can be seen particularly in the images that can be produced by transmission electron microscopy (see FIG. 1).

In such samples the platelet-like particles often appear to overlap. Overlapping particles are generally imaged with greater blackening at the sites of overlapping than are non-overlapping particles. The lengths, widths and heights stated are preferably determined (measured) on non-overlapping particles.

The height of a platelet-like particle can preferably be obtained by determining the dimensions of the particle having its largest area perpendicular to the plane of the image. The particles lying perpendicular to the image plane are distinguished by particularly high contrast (high blackening) and so appear rather rod-like. These platelet-like particles lying perpendicular to the image plane can be identified as actually perpendicular to the image plane if the dimension increases (in at least one spatial direction) and the density (blackening) of the image decreases on tilting of the image plane.

A particularly suitable means for determining the height of a particle is to tilt the image plane of the sample repeatedly into different positions and to determine the dimensions of the particle in the position characterized by the highest contrast/greatest density and the minimum extent of the particle. Then the shortest extent corresponds to the height of the particle.

According to one preferred embodiment, the average length of the particles is preferably 30 to 100 nm.

The width of this particle is then in the range of 10 to 100 nm.

According to a special embodiment, the particles of the inventive sparingly soluble calcium salt and/or composite materials comprising them have a length to width ratio between 1 and 4, preferably between 1 and 3, especially preferably between 1 and 2, such as 1.2 (length 60 nm, width 50 nm) or 1.5 (length 80, width 40 nm).

The platelet-like shape of the particle is formed by the ratio of length to width. If the ratio of length to width is clearly greater than 4, the particles are rather rod-like.

The advantage of the platelet-like particle having a ratio of preferably 1 to 2 is that these particles have a length to width ratio particularly similar to that of the natural bone material, and so exhibit particularly good and biologically compatible remineralization or neomineralization of the tooth material (dentine and enamel).

According to a further special embodiment, the particles have an area of 0.1·10⁻¹⁵ m² to 90·10⁻¹⁵ m², preferably an area of 0.5·10⁻¹⁵ m² to 50·10⁻¹⁵ m², especially preferably 1.0·10⁻¹⁵ m² to 30·10⁻¹⁵ m², and quite particularly preferably 1.5·10⁻¹⁵ m² to 15·10⁻¹⁵ m², such as 2·10⁻¹⁵ m².

The area of the particle is the area of the plane determined by the length and the width perpendicular to it, according to the current geometrical calculation methods.

The present invention is surprisingly successful in producing the calcium salts or composite materials comprising them, according to the invention, in the form of crystalline inorganic nanoparticles which result in particularly effective neomineralization of tooth material (dentine and enamel) as well as bone tissue.

The term “sparingly soluble calcium salt” means those salts that are soluble at less than 0.1% by weight (1 g/L) in water at 20° C. Examples of such suitable salts include, for instance, calcium hydroxyphosphate (Ca₅[OH(PO₄)₃]), hydroxyapatite, calcium fluorophosphate (Ca₅[F(PO₄)₃) or fluoroapatite, fluoride-dosed hydroxyapatite having the composition Ca₅(PO₄)₃(OH, F) and calcium fluoride (CaF₂) or fluorite or fluorspar, as well as other calcium phosphates such as di-, tri- or tetra-calcium phosphate (Ca₂P₂O₇), Ca₃(PO₄)₂, Ca₄P₂O₉, oxyapatite (Ca₁₀(PO₄)₆O) or non-stoichiometric hydroxyapatite (Ca_{5-1/2(x+y)}(PO₄)₃₋ₓ(HPO₄)ₓ(OH)_{1-y}. Carbonate-containing calcium phosphates (such as Ca_{5-1/2(x+y+z)}(PO₄)_{3-x-z}(HPO₄)ₓ(CO₃)_{z}(OH)_{1-y}), calcium hydrogen phosphates (such as CaH(PO₄).2H₂O) and octacalcium phosphate (such as Ca₈H₂(PO₄)₆.5H₂O) are likewise suitable.

The composite materials according to the invention may preferably contain as the calcium salt one or even more salts in a mixture, selected from the group of phosphates, fluorides and fluorophosphates, which may optionally also contain hydroxyl and/or carbonate groups. Hydroxyapatite and fluoroapatite are particularly preferred.

According to another embodiment of the invention, the crystallites and/or particles of the calcium salts, which are free or in the composite materials according to the invention may be enveloped in one or more surface-modification agents.

For example, the production of composite materials is made easier by that means in cases in which it is difficult to disperse the calcium salts. The surface-modification agent is adsorbed at the surface of the crystallite and/or particle and changes it so as to increase the dispersibility of the calcium salt while the agglomeration of the crystallites and/or particles is reduced or essentially prevented.

Furthermore, a surface modification can influence the structure of the sparingly soluble calcium salts and particularly of the composite materials, as well as the charging of the polymer components with the calcium salt. In this way, it is possible when using the composite materials in remineralization processes to influence the course and rate of the remineralization process.

Surface-modification agents are understood to be substances that adhere physically to the surface of the finely divided particles but do not react chemically with them. The individual molecules of the surface-modification agents adsorbed at the surface are essentially free of intermolecular bonds with each other. Surface-modification agents in this meaning include, in particular, dispersing agents. Dispersing agents are also known to those skilled in the art as emulsifiers, protective colloids, wetting agents, detergents, etc.

For example, emulsifiers of the nonionic surfactant type from at least one of the following groups can be considered as surface-modification agents:
addition products of 2 to 30 moles of ethylene and/or 0 to 5 moles of propylene oxide to linear fatty alcohols having 8 to 22 C atoms, to fatty acids having 12 to 22 C atoms, and to alkylphenols having 8 to 15 C atoms in the alkyl group;
C_{12/18} fatty acid monoesters and diesters of addition products of 1 to 30 moles of ethylene oxide to glycerol;
glycerol monoesters and diesters and sorbitan monoesters and diesters of saturated and unsaturated fatty acids having 6 to 22 carbon atoms and their ethylene oxide addition products;
alkyl monoglycosides and oligoglycosides having 8 to 22 carbon atoms in the alkyl group and their ethoxylated analogs;
addition products of 15 to 60 moles of ethylene oxide to castor oil and/or hardened castor oil;
polyol esters, especially polyglycerol esters, such as polyglycerol polyricinoleate, polyglycerol poly-12-hydroxystearate or polyglycerol dimerate. Mixtures of compounds from this class of substances are also suitable.
addition products of 2 to 15 moles of ethylene oxide to castor oil and/or hardened castor oil;
partial esters based on linear, branched, unsaturated or saturated C_{6/22} fatty acids, ricinoleic acid and 12-hydroxystearic acid and glycerol, polyglycerol, pentaerythritol, dipentaerythritol, sugar alcohols (such as sorbitol), alkyl glycosides (such as methyl glucoside, butyl glucoside, lauryl glucoside) and polyglucosides (such as cellulose);
mono-, di- and tri-alkyl phosphates and mono-, di- and/or tri-PEG-alkyl phosphates and their salts;
wool alcohols;
polysiloxane-polyalkyl-polyether copolymers or equivalent derivatives;
mixed esters of pentaerythritol, fatty acids, citric acid and fatty alcohols according to German Patent 1165574 and/or mixed esters of fatty acids having 6 to 22 carbon atoms, methylglucose and polyols, preferably glycerol or polyglycerol, and
polyalkylene glycols.

The addition products of ethylene oxide and/or propylene oxide to fatty alcohols, fatty acids, alkylphenols, glycerol monoesters and diesters, and sorbitan monoesters and diesters of fatty acids or to castor oil are known products that are commercially available. They are mixtures of homologs. Their average degree of alkoxylation corresponds to the ratio of the amounts of ethylene oxide and/or propylene oxide and substrate with which the addition reaction is carried out.

C_{8/18} alkyl monoglycosides and oligoglycosides, their production, and their use, are known in the state of the art. They are produced principally by reaction of glucose or oligosacharides with primary alcohols having 8 to 18 C atoms. With respect to the glycoside groups, both monoglycosides in which a cyclic sugar group is bonded glycosidically to the fatty alcohol and oligomeric glycosides having a degree of oligomerization up to preferably about 8 are suitable. The degree of oligomerization here is a statistical mean determined by the usual homolog distribution for such industrial products.

Typical examples of anionic emulsifiers include soaps, alkylbenzene sulfonates, alkane sulfonates, olefin sulfonates, alkyl ether sulfonates, glycerol ether sulfonates, α-methyl ester sulfonates, sulfofatty acids, alkyl sulfates, alkyl ether sulfates such as fatty alcohol ether sulfates, glycerol ether sulfates, hydroxy-mixed ether sulfates, monoglyceride(ether) sulfates, fatty acid amide (ether) sulfates, monoalkyl and dialkyl sulfosuccinates, monoalkyl and dialkyl sulfosuccinamates, sulfo-triglycerides, amide soaps, ether carboxylic acids and their salts, fatty acid isethionates, fatty acid sarcosinates, fatty acid taurides, N-acylamino acids such as acylglutamate and acylaspartate, alkyl oligoglucoside sulfates, protein fatty acid condensates (especially plant products based on wheat) and alkyl (ether) phosphates. To the extent that the anionic surfactants contain polyglycol ether chains, they may have a conventional, but preferably a narrower-range homolog distribution.

Zwitterionic surfactants can also be used as emulsifiers. Zwitterionic surfactants are those surface-active compounds which have in the molecule at least one quaternary ammonium group and at least one carboxylate and one sulfonate group. Particularly suitable zwitterionic surfactants are the betaines such as N-alkyl-N,N-dimethylammonium glycinates, such as cocoalkyl dimethyl ammonium glycinate, N-acylaminopropyl-N,N-dimethylammonium glycinates such as cocoacyl-aminopropyl dimethylammonium glycinate, and 2-alkyl-3-carboxymethyl-3-hydroxyethylimidazoline, each having 8 to 18 C atoms in the alkyl or acyl group, and cocoacylaminoethyl-hydroxyethyl-carboxymethylglycinate. The fatty acid amide derivative known by the CTFA name cocamidopropyl betaine is particularly preferred. Ampholytic surfactants are also suitable emulsifiers. Ampholytic surfactants are understood to be those surface-active compounds which have in the molecule, aside from a C_{8/18} alkyl or acyl group, at least one free amino group and at least one —COOH or —SO₃H group and which can form internal salts. Examples of suitable ampholytic surfactants include N-alkylglycines, N-alkylpropionic acids, N-alkylaminobutyric acids, N-alkyliminodipropionic acids, N-hydroxyethyl-N-alkylamidopropyl-glycines, N-alkyltaurines, N-alkylsarcosines, 2-alkylaminopropionic acids and alkylaminoacetic acids, each having 8 to 18 C atoms in the alkyl group. Particularly preferred ampholytic surfactants include N-cocoalkylaminopropionate, cocoacylaminoethylaminopropionate and C_{12/18}-acyl sarcosine. Quaternary emulsifiers can also be considered along with the ampholytic ones. Those of the ester-quat type, preferably methyl-quaternized di-fatty acid triethanolamine ester salts, are particularly preferred.

Examples of protective colloids suitable as surface-modification agents include, for instance, natural water-soluble polymers such as gum arabic, starches, water-soluble derivatives of water-insoluble polymeric natural substances, such as cellulose ethers like methycellulose, hydroxyethylcellulose, carboxymethylcellulose or modified carboxymethylcellulose, hydroxyethyl starches or hydroxypropyl guar, as well as synthetic water-soluble polymers such as polyvinyl alcohol, polyvinylpyrrolidone, polyalkylene glycols, polyaspartic acid and polyacrylates.

The surface-modification agents are generally used at a concentration of 0.1 to 50% by weight, but preferably 1 to 20% by weight, based on the calcium salt.

Nonionic surfactants, in a proportion of 1 to 20% by weight, based on the weight of the calcium salt, are outstandingly suitable as surface-modification agents. The nonionic surfactants of the type of the alkyl-C₈-C₁₆-(oligo)-glucosides and the ethoxylates of hardened castor oil have proven to be particularly effective.

According to a particular embodiment the composite materials according to the invention comprise
Sparingly water-soluble calcium salts, the calcium salts occurring in the form of individual crystallites or in the form of particles comprising a multiplicity of the said crystallites, with a mean particle diameter in the range of less than 1,000 nm, preferably less than 300 nm, and
a polymer component
   wherein the particles in the composite material are rod-like and/or platelet-like, preferably predominantly platelet-like.

Composite materials are understood to be compound materials comprising the components specified in a) and b) and are microscopically heterogeneous but macroscopically homogeneous-appearing aggregates, and in which the crystallites or particles of the calcium salt occur associated with the structure of the polymer component. The proportion of polymer components in the composite materials is between 0.1 and 80% by weight, preferably between 10 and 60, and especially between 30 and 50% by weight, based on the total weight of the composite material.

The composite materials according to the invention are therefore structured composite materials in contrast to the composite of hydroxyapatite and collagen described by R. Z. Wang et al., in which there are evenly distributed hydroxyapatite nanoparticles. A further significant difference between the object of the present invention and the state of the art consists of the size and morphology of the inorganic component. The hydroxyapatite particles described by R. Z. Wang et al. have a size of 2-10 nm. Hydroxyapatite particles in this size range are considered to be in the region of amorphous or partially x-ray amorphous materials.

A further advantage of the composite materials is that they do not tend to aggregate strongly, so that they can be processed better in production. In particular, improved dispersibility of the composite can be observed.

According to a special embodiment, the polymer component is selected from a protein component, protein hydrolysates and derivatives of protein hydrolysates.

One preferred embodiment of the invention consists of using protein hydrolysates as the polymer component.

In the sense of the invention, polyacids and polybases may be considered as the protein hydrolysate. The protein hydrolysates can be biopolymers or synthetic polymers. Thus the compositions according to the invention contain, for example, one or more protein hydrolysates selected from
alginic acids,
pectins,
carrageenan,
polygalacturonic acids,
amino and amino acid derivatives of alginic acids, pectins, carrageenan and polygalacturonic acids,
polyamino acids such as polyaspartic acids,
polyaspartamides,
nucleic acids, such as DNA and RNA,
lignin sulfonates,
carboxymethylcelluloses,
cyclodextrin, cellulose, or dextran derivatives containing amino groups and/or carboxyl groups,
polyacrylic acids,
polymethacrylic acids,
polymaleates,
polyvinylsulfonic acids,
polyvinylphosphonic acids,
polyethyleneimines,
polyvinylamines,
   and derivatives of the substances named above, especially amino and/or carboxyl derivatives. In the sense of the present invention it is preferable to use protein hydrolysates bearing groups suitable for forming salts with divalent cations. Polymers bearing carboxylate groups are particularly suitable.

Electrolytes that are particularly preferred in the sense of the invention are polyaspartic acids, alginic acids, pectins, deoxyribonucleic acids, ribonucleic acids, polyacrylic acids and polymethacrylic acids.

Polyaspartic acids having molecular weights in the range between about 500 and 10,000 Dalton, especially 1,000 to 5,000 Dalton, are quite particularly preferred.

Another preferred embodiment of the invention consists of selecting polysaccharides as polymer components. In particular, these polysaccharides are selected from polysaccharides containing glucuronic acid and/or iduronic acid. That is understood to include those polysaccharides made up of, among other groups, glucuronic acid, preferably D-glucuronic acid and/or iduronic acid, especially L-iduronic acid. There glucuronic acid or iduronic acid forms part of the carbohydrate structure. Iduronic acid, which is an isomer of glucuronic acid, has the opposite configuration at the C5 carbon atom of the ring. It is preferably understood that among the polysaccharides containing glucuronic acid and/or iduronic acid, those containing glucuronic acid or iduronic acid in a molar ratio of 1:10 to 10:1, preferably 1:5 to 5:1, especially preferably 1:3 to 2:1, based on the sum of the other monosaccharide components of the polysaccharide, are preferred. Particularly good interaction with the calcium salt can be attained by the polysaccharides containing glucuronic acid and/or iduronic acid because of the anionic carboxyl groups of the glucuronic acid and/or iduronic acid. That results in a particularly stable and simultaneously well-mineralizing composite material. Examples of suitable polysaccharides include the glycosaminoglycans (also known as mucopolysaccharides) containing glucuronic acid and/or iduronic acid, microbially produced xanthan or welan, or gum arabic, which is obtained from acacias.

One advantage of the composite materials according to the invention is their particular stability in aqueous systems, even without addition of dispersant aids such as multifunctional alcohols (such as glycerol or polyethylene glycols).

According to a particularly preferred embodiment the polymer component is selected from a protein component, preferably from proteins, protein hydrolysates and their derivatives.

Essentially all proteins, independently of their origin or preparation, can be considered as proteins in the context of the present invention. Examples of proteins of animal origin include keratin, elastin, collagen, fibroin, albumin, casein, whey protein, and placental protein. Of those, collagen, keratin, casein, and whey protein are preferred according to the invention. Proteins of plant origin, such as wheat and wheat germ proteins, rice protein, soy protein, oat protein, pea protein, potato protein, almond protein and yeast protein can likewise be preferred according to the invention.

In the sense of the present invention, degradation products of proteins such as collagen, elastin, casein, keratin, almond, potato, wheat, rice and soy protein which are obtained by acidic, alkaline, and/or enzymatic hydrolysis of the proteins themselves, or their degradation products such as gelatin, are understood to be protein hydrolysates. All hydrolytic enzymes are suitable for the enzymatic degradation, for instance, alkaline proteases. Other suitable enzymes and enzymatic hydrolysis procedures are described, for instance, in K. Drauz and H. Waldmann, Enzyme Catalysis in Organic Synthesis, VCH-Verlag, Weinheim, 1975. On degradation, the proteins are split into smaller subunits. The degradation can pass through the stages of polypeptides through oligopeptides to the individual amino acids. The less-degraded proteins include particularly the gelatins that are preferred in the context of the present invention. They can have molecular weights in the range of 15,000 to 250,000 Daltons. Gelatin is a polypeptide obtained primarily by hydrolysis of collagen under acidic conditions (Gelatin type A) or alkaline conditions (Gelatin type B). The gel strength of the gelatin is proportional to its molecular weight. That is, a more strongly hydrolyzed gelatin yields a less viscous solution. The gel strength of the gelatin is reported in Bloom numbers. In the enzymatic splitting of gelatin, the size of the polymer is greatly reduced, resulting in very low Bloom numbers.

The protein hydrolysates commonly used in cosmetics, having average molecular weights in the range of 600 to 4,000, especially preferably 2,000 to 3,500, are also used preferably as protein hydrolysates in the context of the present invention. Surveys on production and use of protein hydrolysates are, for example, those by G. Schuster and A. Domsch in Seifen Öle Fette Wachse [Soaps, Oils, Fats, Waxes] 108 (1982) 177 or Cosm. Toil. 99 (1984) 63, by H. W. Steisslinger in Parf. Kosm. 72 (1991) 556, and F. Aurich et al. in Tens. Surf. Det. 29 (1992) 389. Protein hydrolysates from collagen, keratin, casein and plant proteins are used preferably according to the invention, especially those based on wheat gluten or rice protein. Their preparation is described in two German patents, DE 19502167 C1 and DE 19502168 C1 (Henkel).

In the context of the present invention, protein hydrolyzate derivatives are understood to include chemically and/or chemoenzymatically modified protein hydrolysates such as these compounds, known by their INCI names: sodium cocoyl hydrolyzed wheat protein laurdimonium hydroxypropyl hydrolyzed wheat protein, potassium cocoyl hydrolyzed collagen, potassium undecylenoyl hydrolyzed collagen and laurdimonium hydroxypropyl hydrolyzed collagen. Derivatives of protein hydrolysates of collagen, keratin and casein and of plant protein hydrolysates such as sodium cocoyl hydrolyzed wheat protein or laurdimonium hydroxypropyl hydrolyzed wheat protein are used preferably according to the invention.

Other examples of protein hydrolysates and protein hydrolyzate derivatives that are within the scope of the present invention are described in CTFA 1997 International Buyers Guide, John A. Wenninger et al. (Ed.), The Cosmetic, Toiletry, and Fragrance Association, Washington D.C. 1997, 686-688.

In each of the composite materials according to the invention, the protein component can be made up of one or more substances selected from the group of proteins, protein hydrolysates and protein hydrolyzate derivatives.

All the structure-forming proteins, protein hydrolysates and protein hydrolyzate derivatives are preferred as protein components. Those protein components are understood to be those which form three-dimensional spatial structures because of their chemical constitution. They are familiar to those skilled in the art from protein chemistry under the concepts of secondary, tertiary, or even quaternary structure.

According to a particularly preferred application, the protein component of the composite material is selected from collagen, gelatins, casein, and their hydrolysates, preferably gelatins, especially preferably gelatin of Type A, B or AB, and particularly Gelatins of the acid bone type.

According to a particularly preferred embodiment, gelatins of Type AB can be used. They are also known by the names “acid bone” or “acid process ossein” gelatins, and are produced from ossein under strongly acidic process conditions.

Ossein, the collagen-containing starting material for producing gelatins of Type AB, “acid bone” or “acid process ossein,” is made as an extract of ground bone, especially beef bone, After optional defatting and drying, it is held for one or more days (preferably at least a week or more) in aqueous solution, preferably cold acid, preferably dilute acid (e.g., hydrochloric acid) to remove the inorganic components of the bone, especially hydroxyapatite and calcium carbonate. This produces a spongy demineralized bone material, ossein.

The collagen in the ossein is denatured and released by a digestion process in which the material is treated under strongly acidic conditions.

The gelatins are produced from the raw materials named by multiple extraction with aqueous solutions. The pH of the solution can preferably be adjusted before the extraction process. Multiple extraction steps with water or aqueous solutions at increasing solvent temperature are especially preferable.

Composite materials that can be obtained from a sparingly water-soluble calcium salt with gelatins of Type AB (acid-bone) are particularly suitable for use in the applications according to the invention.

Now it has been found, surprisingly, that the composite materials containing gelatins of Type AB, “acid bone,” exhibit particularly strong neomineralization. Composite materials that can be obtained from a sparingly water-soluble calcium salt with gelatins of Type AB (acid-bone) are thus particularly suitable for use in bones and teeth (see Examples). The composite materials according to the invention are therefore preferred, in comparison with the composites named, for use, especially for rapid sealing of dentinal tubules, for remineralization of the tooth material, for use in teeth and bones to prevent and/or treat damage due to external influences, especially physiological, chemical, physical and/or microbiological in nature, e.g., in case of erosion, primary lesions and initial caries, as well as for caries prophylaxis, to improve resistance to mechanical stress and generally to improve the cleaning properties of the teeth and dental health in general.

The sparingly water-soluble calcium salts or composite materials comprising them can be produced by precipitation reactions from aqueous solutions of water-soluble calcium salts and aqueous solutions of water-soluble phosphate and/or fluoride salts. In the case of the composite materials according to the invention the precipitation is carried out in the presence of polymer components.

The composite materials according to the invention are preferably produced by adding the polymer components in pure, dissolved or colloidal form to the neutral or alkaline aqueous phosphate and/or fluoride salt solution or to the neutral or alkaline solution of the calcium salt before the precipitation reaction. Alternatively, the polymer components can be made up in pure, dissolved or colloidal form and then mixed, successively in arbitrary sequence, or simultaneously, with the neutral or alkaline calcium salt solution and with the neutral or alkaline phosphate and/or fluoride salt solution. “Neutral solutions” are to be understood as solutions having a pH between about 6.5 and about 7.5.

In the production process according to the invention, the individual components can fundamentally be combined in all possible sequences. Ammonia is used preferably as the alkalizing agent.

A further variant of the production process according to the invention consists of performing the precipitation from an acidic solution of a water-soluble calcium salt together with a stoichiometric quantity of a water-soluble phosphate and/or fluoride salt or from an acidic solution of hydroxyapatite having a pH below 5, preferably at a pH below 3, by raising the pH with aqueous alkali or ammonia in the presence of the polymer components.

A further variant of the process consists of mixing nanoparticulate calcium salts in pure or dispersed form, or dispersions of nanoparticulate calcium salts prepared by precipitation reactions from aqueous solutions of water-soluble calcium salts and aqueous solutions of water-soluble phosphate and/or fluoride salts with the polymer components, the latter preferably in dissolved or dispersed form. Any desired sequence can be selected for the addition.

It is preferable to start with the solution or dispersion of the polymer components and to add a dispersion of the nanoparticulate calcium salt to it.

For all the production processes mentioned, the resulting dispersion of the composite material can be separated from solvents and the other components of the reaction mixture as needed by processes known to those skilled in the art, such as filtration or centrifugation, and isolated in the solvent-free form by subsequent drying, such as freeze-drying.

Water is the preferred solvent in all the production processes, but organic solvents, such as monofunctional or polyfunctional alcohols with 1 to 4 C atoms, or glycerol, can also be used in individual steps of production.

The calcium salts or composite materials comprising them, and in particular those composite materials having a protein component selected from collagen, casein or gelatins, preferably gelatins of the AB type, with surface-modified crystallites and/or particles of the calcium salt, can be produced by precipitation reactions analogous to those described above, but in which the precipitation of the nanoparticulate calcium salt or the composite materials is carried out in the presence of one or more surface-modification agents.

It is preferable to produce the surface-modified nanoparticulate calcium salt by an initial precipitation reaction between aqueous solutions of calcium salts and aqueous solutions of phosphate and/or fluoride salts in the presence of the surface-modification agent. They can then be freed of byproducts in the reaction mixture, for instance, by evaporation under reduced pressure and subsequent dialysis. In addition, a dispersion of the surface-modified calcium salt having a desired proportion of solids can be made by removal of the solvent. Then the composite material of surface-coated calcium slat and polymer components is made by adding the polymer components in pure, dissolved or colloidal form, with the sequence of the addition again noncritical, and, if necessary, a further reaction at elevated temperature, preferably in the range between 50 and 100° C. and for a duration of 1 to 100 minutes, forming the composite material from the surface-coated calcium salt and the polymer components.

Precipitation of the calcium salt or of the composite material at a pH between 5 and 9, preferably between 6 and 8, especially preferably about 7, is particularly suitable for producing a calcium salt or composite material according to the invention which contains predominantly platelet-like particles.

To develop the composite materials preferred according to the invention it is preferable to make a solution of a calcium salt with the polymer component and to add to it, slowly, a phosphate solution, with the pH between 5 and 9, preferably between 6 and 8, and particularly preferably about 7. It is especially preferable to hold the pH constant during addition of the phosphate solution by adding appropriate quantities of an aqueous base.

Other processes, such as those described in German Patent Application DE 19858662.0, can be used to produce dispersions of surface-modified calcium salts.

The calcium salts or composite materials containing them according to the invention, and in particular those composite materials having a protein component selected from collagen, casein or gelatins, especially preferably gelatins of types A, B or AB, and especially gelatin of the acid bone type, those of hydroxyapatite, fluoroapatite and calcium fluoride, are suitable as mineralizing components to product compositions for cleaning teeth and/or dental care.

The effect of hardening the enamel and closure of lesions and dentinal tubules occurs particularly rapidly and completely because of the structured form, particularly of the preferred composite and the particle size of the calcium compounds contained therein.

Furthermore, calcium salts or composite materials comprising them according to the invention, and especially those composite materials having a protein component selected from collagen, casein or gelatins, especially preferably gelatins of Types A, B or AB, particularly gelatin of the acid bone type, can be used as neomineralizing or remineralizing components in compositions for hardening the enamel.

Another use of the calcium salts or composite materials comprising them, and especially those composite materials having a protein component selected from collagen, casein or gelatins, especially preferably gelatins of Types A, B or AB, particularly gelatin of the acid bone type is as components for inducing or promoting biomineralization for treatment of tooth or bone defects.

The calcium salts or composite materials comprising them according to the invention, and especially those composite materials having a protein component selected from collagen, casein or gelatins, especially preferably gelatins of Types A, B or AB, particularly gelatin of the acid bone type, or compositions containing them, can also be used to coat implants.

It is also preferred to use the calcium salts or composite materials comprising them according to the invention, and especially those composite materials having a protein component selected from collagen, casein or gelatins, especially preferably gelatins of Types A, B or AB, particularly gelatin of the acid bone type, or compositions containing at least those, to smooth the surfaces of teeth and/or bones.

The calcium salts or composite materials comprising them according to the invention, and especially those composite materials having a protein component selected from collagen, casein or gelatins, especially preferably gelatins of Types A, B or AB, particularly gelatin of the acid bone type, especially those of hydroxyapatite and fluoroapatite, can induce or promote biomineralization in bone tissue. Thus they are further suitable as biomineralizing components to make compositions for restoring or new formation of bone material, e.g., compositions for treating bone defects and bone fractures and to promote in-growth of implants.

A further object of the invention concerns the use of the calcium salts or composite materials comprising them according to the invention, and especially those composite materials having a protein component selected from collagen, casein or gelatins, especially preferably gelatins of Types A, B or AB, particularly gelatin of the acid bone type, for protection and/or for therapeutic and/or preventive treatment of teeth and/or bones before or after injuries due to external influences, especially physiological, chemical, physical and/or microbiological in nature, especially for prevention and repair of erosions of bones and teeth, especially dental enamel, care of the dental enamel, and for protection of the teeth from attacks by acids, especially those due to bacterial activity or action of acids from foods, for protection against demineralization of the teeth, for sealing fissures, to protect against and/or to repair primary lesions and/or initial caries in the dental enamel and to smooth the surfaces of the teeth, to prevent caries, to improve the ability to clean, the mechanical resistance of the teeth, and general dental health.

According to a preferred embodiment, the calcium salts according to the invention, and preferably the composite materials comprising them, especially those composite materials having a protein component selected from collagen, casein or gelatins, especially preferably gelatins of Types A, B or AB, particularly gelatin of the acid bone type, are used against attacks by acids.

The term “acids” is understood here to mean both the intrinsic acids and the extrinsic acids. Damage from intrinsic acids concerns particularly medically related clinical pictures involving contact of the oral region with stomach acid, particularly in case of expulsion, regurgitation, heartburn, or vomiting, and also in relation to pathological eating disturbances, such as bulimia, in particular.

Use in case of attack by extrinsic acids, particularly those due to bacterial activity or action of acids from foods, is particularly suitable.

It has also been observed that in addition to prevention of erosion of teeth (dentine and enamel) and bones, there is also repair of erosions on teeth and bones, especially of the enamel, due to the composite materials according to the invention.

The calcium salts according to the invention, and preferably the composite materials comprising them, particularly those composite materials having a protein component selected from collagen, casein or gelatins, especially preferably gelatins of Types A, B or AB, particularly gelatin of the acid bone type, are therefore also usable therapeutically to repair damages, especially erosions, of bones and teeth, particularly of enamel.

Preferably the calcium salts according to the invention, and preferably the composite materials comprising them, particularly those composite materials having a protein component selected from collagen, casein or gelatins, especially preferably gelatins of Types A, B or AB, particularly gelatin of the acid bone type, are used to protect against and/or to repair primary lesions and/or initial caries in the dental enamel and to seal fissures. According to the invention, fissures (that is, crack-like intrusions on the chewing surfaces of the premolars and molars) can be sealed, so that their susceptibility to caries is reduced.

Furthermore, use of the calcium salts according to the invention, and preferably the composite materials comprising them, particularly those composite materials having a protein component selected from collagen, casein or gelatins, especially preferably gelatins of Types A, B or AB, particularly gelatin of the acid bone type results in better mechanical resistance, especially such that the extent of microcracks, microcraters, or mechanical abrasion is reduced.

The use according to the invention leads to better resistance to mechanical stress on the teeth, which can be caused not only by chewing but also, in particular, by vigorous brushing. Damage or removal of softened enamel can be avoided in this manner.

Because of the stated positive properties of the sparingly water-soluble calcium salts and/or the composite materials comprising them, especially of the composite materials, particularly those composite materials having a protein component selected from collagen, casein or gelatins, especially preferably gelatins of Types A, B or AB, particularly gelatin of the acid bone type, they themselves or compositions containing them can thus be used generally to improve the ability to clean the teeth and to improve dental health in general.

The compositions for cleaning and care of the teeth can, for example, be in the form of pastes, liquid creams, gels or mouth washes. The composite materials according to the invention distribute themselves easily even in liquid preparations. They remain stable in dispersion and do not tend to sediment.

The concentration of the sparingly water-soluble calcium salts or composite materials comprising them, preferably of the composite materials, especially those having a protein component selected from collagen, casein or gelatins, especially preferably gelatins of Types A, B or AB, particularly gelatin of the acid bone type, in the oral and dental care materials according to the invention is 0.01 to 10% by weight, preferably 0.01 to 2% by weight, based on the total weight of the material.

The oral and dental care materials according to the invention can also contain 0.1 to 9% by weight, especially 2 to 8% by weight, of at least one cleaning agent.

Cleaning agents are among the essential components of a toothpaste. They occur alone or in combination with other cleaning agents or polishing agents, depending on their intended function. They provide mechanical removal of the uncalcified dental plaque and should ideally result in polishing of the tooth surface (polishing action) with simultaneous minimal scrubbing (abrasive action) and damage to the enamel and dentine. The abrasive action of the polishing agents and cleaning materials is determined essentially by their hardness, particle size distribution and surface structure. In selection of suitable cleaning materials, accordingly, those with high cleaning power and minimal abrasive action are preferred.

Substances with small particle sizes, largely free of sharp corners and edges, with hardness and mechanical properties that do not excessively stress the tooth or the tooth substance are used predominantly as cleaning materials at present.

Water-insoluble inorganic substances are usually used as cleaning materials or polishing agents. It is particularly advantageous to use very finely divided polishing agents having a mean particle size of 1-200 μm, preferably 1-50 μm, and particularly 1-10 μm.

In principle, the polishing agents according to the invention can be selected from silicic acids, aluminum hydroxide, aluminum oxide, silicates, organic polymers, or mixtures of those. The materials according to the invention can also contain the metaphosphates, alkaline earth metal carbonates or bicarbonates, and calcium-containing polishing components.

It can be preferred according to the invention to use silicic acids as polishing agents in toothpastes or liquid tooth-cleaning materials. One distinguishes among the silicic acid polishing agents, basically between gel silicic acids, hydrogel silicic acids and precipitation silicic acids. Precipitation and gel silicic acids are especially preferred according to the invention, as they can be varied widely in their production and are particularly compatible with fluoride agents. They are also particularly suitable for the production of gel or liquid tooth creams.

Gel silicic acids are produced by reaction of sodium silicate solutions with strong aqueous mineral acids, forming a hydrosol, aging to the hydrogel, washing and subsequent drying. If drying is done under gentle conditions to water contents of 15 to 35% by weight, the hydrogel silicic acids such as those described in U.S. Pat. No. 4,153,680 are obtained. On drying of these hydrogel silicic acids to water contents below 15% by weight, the previously open structure shrinks to the dense structure of the “xerogel.” Such xerogel silicic acids are known from U.S. Pat. No. 3,538,230, for example.

The precipitation silicic acids are a second and preferably suitable group of silicic acid polishing agents. They are obtained by precipitating silicic acid from dilute alkali silicate solutions by adding strong acids under conditions such that aggregation to the sol and gel cannot occur. Suitable processes for producing precipitation silicic acids are described, for example, in German Laid-Open Applications 25 22 586 and 31 14 493. A precipitation silicic acid produced according to German Laid-Open Application 31 14 193 is particularly suitable according to the invention. It has a BET surface area of 15-110 m²/g, a particle size of 0.5 to 20 μm, in which at least 80% by weight of the primary particles should be below 5 μm, and a viscosity in 30% glycerol-water (1:1) dispersion of 30-60 Pa S (20° C.). It is used at a proportion of 10-20% by weight in the toothpaste. Preferred suitable precipitation silicic acids of this type also have rounded corners and edges. They are obtainable, for example, from Degussa under the tradename Sident® 12 DS.

Other precipitation silicic acids of this type are Sident® 8 from Degussa and Sorbosil® AC 39 from Crosfield chemicals. These silicic acids are characterized by lower thickening action and a somewhat greater mean article size of 8-14 μm with a specific surface of 40-75 m²/g (by BET). They are particularly suitable for liquid tooth creams. They are reported to have a viscosity of 10-100 Pa S (25° C., shear rate D=10 s⁻¹).

Silicic acids of the Zeodent® type from Huber Corp., Tixosil® from Rhodia, and other Sorbosil types can also be used in the materials according to the invention. Zeodent®113, Tixosil® 123 and Sorbosil® AC39 are particularly preferred.

Toothpastes, on the other hand, having a distinctly higher viscosity greater than 100 Pa S (25° C., D=10 s⁻¹), require a sufficiently high proportion of silicic acids having particle sizes of less than 5 u, preferably at least 3% by weight of a silicic acid having a particle size of 1 to 3 μm. It is preferable to add, along with the precipitation silicic acids mentioned, even more finely divided, “thickening silicic acids” with a BET surface of 150-250 m²/g. Sipernat® 22 LS or Sipernat® 320 DS from Degussa must be mentioned as examples of commercial products that meet the specified conditions.

A weakly calcined alumina having a content of α- and γ-aluminum oxides in a proportion of about 0.01 to 5% by weight, preferably 0.1 to 2% by weight, based on the total weight of the material, is preferably suitable as an aluminum oxide polishing agent.

Suitable weakly calcined aluminas are produced from aluminum hydroxide by calcining. On calcining, aluminum hydroxide converts to thermodynamically stable α-Al₂O₃ at temperatures above 1200° C. The thermodynamically unstable Al₂O₃ modifications that appear at temperatures between 400 and 1,000° C. are called gamma forms (see Ullmann, Enzyclopädia der technischen Chemie [Encyclopedia of Industrial Chemistry], Vol. 7, page 298). One can adjust the degree of calcination, i.e., the conversion to the thermodynamically stable α-Al₂O₃, to any desired level by selecting the temperature and duration of the calcination. By weak calcination, one gets an alumina with a content of γ-Al₂O₃ that decreases with increasing calcination temperature and longer calcination duration. Weakly calcined aluminas differ from pure α-Al₂O₃ in having lower hardness of the agglomerates, greater specific surface and greater pore volumes.

The dentine abrasion (RDA) of the more weakly calcined aluminas with 10-50% by weight of γ-Al₂O₃, which are to be used according to the invention, is only 30-60% of that for a strongly calcined pure α-Al₂O₃ (measured in a standard toothpaste with 20% by weight alumina as the sole polishing agent).

In contrast to α-Al₂O₃, the γ-Al₂O₃ can be stained red with an aqueous ammoniacal solution of Alizarin S (1,2-dihydroxy-9,10-anthraquinone-4-sulfonic acid). One can choose the degree of stainability as a measure of the degree of calcination or of the proportion of δ-Al₂O₃ in a calcined alumina: Place about 1 g Al₂O₃, 10 ml of a solution of 2 g/L Alizarin S in water and 3 drops of a 10% by weight aqueous solution of NH₃ in a test tube and boil briefly. Then filter off the Al₂O₃, wash it and dry it. Evaluate it microscopically or calorimetrically.

Suitable weakly calcined aluminas containing 10-50% by weight of γ-Al₂O₃ stain pale to deep pink by this procedure.

Aluminum oxide polishing agents of various degrees of calcination, fineness of grind, and bulk density are commercially available, such as the “polishing aluminas” from Giulini-Chemie or ALCOA.

A suitable preferred grade, “Polishing alumina P10 finest” has an agglomerate size of less than 20 μm, a mean primary crystallite size of 0.5-1.5 μm, and a bulk density of 500-600 g/L.

Use of silicates as components of polishing materials can also be preferred according to the invention. They are used particularly as cleaning agents in modern practice. Examples of silicates usable according to the invention include aluminum silicates and zirconium silicates. In particular, sodium aluminum silicate with the empirical formula Na₁₂(AlO₂)₁₂(SiO₂)₁₂.7H₂O can be a suitable polishing agent, as is the synthetic Zeolite A, for example.

Examples of water-insoluble metaphosphates according to the invention include in particular sodium metaphosphate, calcium phosphate, such as tricalcium phosphate, calcium hydrogen phosphate, calcium hydrogen phosphate dihydrate and calcium pyrophosphate.

Magnesium carbonate, magnesium hydrogen phosphate, trimagnesium phosphate or sodium bicarbonate can also be used as polishing materials according to the invention, especially mixed with other polishing materials.

Another polishing material suitable for use in the oral and dental care materials according to the invention is calcium phosphate dihydrate (CaHPO₄.2H₂O). Calcium phosphate dihydrate occurs naturally as brushite. It is commercially available as a polishing material at suitable particle sizes of 1 to 50 μm).

Oral and dental care materials which contain in addition 0.1 to 10% by weight, preferably 0.1 to 5% by weight, and particularly 0.1 to 3% by weight, based in each case on the total weight of the material, of a component that promotes remineralization, are preferred according to the invention.

In the materials according to the invention, the component promoting remineralization promotes remineralization of the dental enamel and closing of dental lesions. It is selected from fluorides, or microparticulate phosphate salts of calcium such as calcium glycerophosphate, calcium hydrogen phosphate, hydroxyapatite, fluoroapatite, fluoride-dosed hydroxyapatite, dicalcium phosphate dihydrate and calcium fluoride. However, magnesium salts such as magnesium sulfate, magnesium fluoride or magnesium monofluorophosphate also have remineralizing action.

Magnesium salts are preferred components promoting remineralization according to the invention.

Suitable embodiments of the oral and dental care materials according to the invention are solid, liquid, or semiliquid toothpastes and tooth gels.

According to a further preferred embodiment, the oral and dental care materials according to the invention also contain toothpaste ingredients such as surfactants, moisture retention agents, binders, flavors and substances active against tooth and gum diseases.

Surface-active surfactants or surfactant mixtures are usually used to improve cleaning action and foaming in the oral and dental care materials according to the invention. They promote rapid and complete dissolution and distribution of tooth cream in the oral cavity and at the same time they support the mechanical removal of the dental plaque, especially at the places that are hard to reach with a toothbrush. They also favor incorporation of water-insoluble substances, such as aromatic oils, stabilize the polishing material dispersion, and support the anti-caries action of fluorides.

Anionic, zwitterionic, ampholytic, nonionic and cationic surfactants or mixtures of them can, in principle, be used as surfactants in tooth cream formulations. According to the invention, tooth creams preferably contain at least one surfactant from the group of anionic surfactants.

The surfactant or mixture of surfactants is usually used in the preparations according to the invention at a proportion of 0.1-10% by weight, preferably 0.3-7% by weight, and particularly 1-5% by weight, based on the total weight of the composition.

### Anionic Surfactants.

Anionic surfactants are suitable surfactants with good foaming action. They also exhibit a certain enzyme-inhibiting action on the bacterial metabolism of the dental plaque.

They include, for instance, alkali or ammonium salts, especially sodium salts, of C₈-C₁₈ alkanecarboxylic acids, of alkyl polyglycol ether sulfates having 12-16 C atoms in the linear alkyl group and 2-6 glycol ether groups in the molecule, of linear alkane-(C₁₂-C₁₈)-sulfonates, sulfosuccinic acid monoalkyl (C₁₂-C₁₈) esters, sulfated fatty acid monoglycerides, sulfated fatty acid alkanolamides, sulfoacetic acid alkyl-(C₁₂-C₁₆)-esters, acyl sarcosines, acyl taurides and acyl isethionates, each having 8-18 C atoms in the acyl group.

Use of at least one anionic surfactant is preferred, especially a sodium lauryl alkyl sulfate having 12-18 C atoms in the alkyl group. One such surfactant is sodium lauryl sulfate which is commercially available, for example, as Texapon® K12 G.

### Zwitterionic and Ampholytic Surfactants.

Use of zwitterionic and/or ampholytic surfactants, preferably combined with anionic surfactants, can be preferred according to the invention. Those surface-active compounds that have at least one quaternary ammonium group, at least one carboxylate, and one sulfonate group in the molecule are called zwitterionic surfactants. Particularly suitable zwitterionic surfactants are the so-betaines such as N-alkyl-N,N-dimethylammonium glycinate, such as trimethylammonium glycinate, coco alkyl dimethylammonium glycinate, N-acylaminopropyl-N,N-dimethylammonium glycinates, such as cocoacyl aminopropyl dimethylammonium glycinate and 2-alkyl-3-carboxymethyl-3-hydroxyethylimidazoline, each having 8 to 18 C atoms in the alkyl or acyl group, and cocoacylaminoethyl hydroxyethyl carboxymethyl glycinate. The fatty acid amide derivative known by the CTFA name of cocamidopropyl betaine is especially preferred. Such products are commercially available, for example, under the tradenames of Tego-Betain® BL-215 and ZF 50, as well as Genagen® CAB.

Ampholytic surfactants are understood to be those surface-active compounds that contain in the molecule not only a C₈-C₁₈ alkyl or acyl group but also at least one free amino group and at least one —COOH or —SO₃H group and which are able to form internal salts. Examples of suitable ampholytic surfactants include N-alkylglycines, N-alkylpropionic acids, N-alkylaminobutyric acids, N-alkyliminodipropionic acids, N-hydroxyethyl-N-alkylamidopropyl glycines, N-alkyltaurines, N-alkylsarcosines, 2-alkylaminopropionic acids and alkylaminoacetic acids, each having some 8 to 18 C atoms in the alkyl group. N-cocolalkylaminopropionate, cocoacylaminoethylaminopropionate and C₁₂-C₁₈-acylsarcosine are especially preferred ampholytic surfactants. Aside from the ampholytic surfactants, quaternary emulsifiers can also be considered. Those of the esterquat type, preferably methyl-quaternized di-fatty acid triethanolamine ester salts, are preferred.

### Nonionic Surfactants.

Nonionic surfactants are particularly suited for supporting the cleaning action according to the invention. Those nonionic surfactants that are selected from at least one of the following groups are particularly preferred:
addition products of 2 to 30 moles of ethylene oxide and/or 0 to 5 moles of propylene oxide to linear fatty alcohols with 8 to 22 C atoms, to fatty acids with 12 to 22 C atoms and to alkyl phenols with 8 to 15 C atoms in the alkyl group;
C₁₂-C₁₈ fatty acid monoesters and diesters of addition products of 1 to 30 moles of ethylene oxide to glycerol;
glycerol monoesters and diesters and sorbitan monoesters and diesters of saturated and unsaturated fatty acids having 6 to 22 carbon atoms, and their ethylene oxide diesters and sorbitan monoesters and diesters of saturated and unsaturated fatty acids having 6 to 22 carbon atoms, and their ethylene oxide addition products;
alkyl monoglycosides and oligoglycosides having 8 to 22 carbon atoms in the alkyl group and their ethoxylated analogs;
Addition products of 15 to 60 moles of ethylene oxide to castor oil and/or hardened castor oil;
polyol esters and especially polyglycerol esters such as polyglycerol polyricinoleate, polyglycerol poly-12-hydroxystearate or polyglycerol dimerate.

Mixtures of compounds from more than one of these substance classes are also suitable;
addition products of 2 to 15 moles of ethylene oxide to castor oil and/or hardened castor oil;
partial esters based on linear, branched, unsaturated or saturated C₆-C₂₂ fatty acids, ricinoleic acid and 12-hydroxystearic acid and glycerol, polyglycerol, pentaerythritol, dipentaerythritol, sugar alcohols (such as sorbitol), sucrose, alkyl glucosides (such as methyl glucoside, butyl glucoside, or lauryl glucoside) and polyglucosides (such as cellulose);
mono, di, and tri-alkyl phosphates and mono, di and/or tri-PEG-alkyl phosphates and their salts;
wool alcohols;
polysiloxane-polyalkyl-polyether copolymers or corresponding derivatives;
mixed esters of pentaerythritol, fatty acids, citric acid and fatty alcohol according to German Patent 1165574 and/or mixed esters of fatty acids having 6 to 22 carbon atoms, methylglucose and polyols, preferably glycerol or polyglycerol, and
polyalkylene glycols.

The addition products of ethylene oxide and/or propylene oxide to fatty alcohols, fatty acids, alkylphenols, glycerol monoesters and diesters, and sorbitan monoesters and diesters of fatty acids or to castor oil are known products that are commercially available and are preferred according to the invention. These are mixtures of homologs with an average degree of alkoxylation equivalent to the ratio of the quantities of ethylene oxide and/or propylene oxide and substrate with which the addition reaction was carried out. C₁₂-C₁₈ fatty acid monoesters and diesters of addition products of ethylene oxide to glycerin are known from German Patent 2024051 as fat-replacement agents for cosmetic preparations.

C₈-C₁₈-alkyl monoglycosides and oligoglycosides, their production, and their use are known from the state of the art, for example, from U.S. Pat. No. 3,839,318, DE-A-20 36 472, EP-A-77 167 OR WO A-93/10132. They are produced principally by reacting glucose or oligosaccharides with primary alcohols having 8 to 18 C atoms. With respect to the glycoside group, both monoglycosides, in which a cyclic sugar group is bound glycosidically to the fatty alcohol and oligomeric glycosides with a degree of oligomerization up to preferably about 8 are suitable. Here the degree of oligomerization is a statistical average based on the usual homolog distribution for such industrial products. An alkyl-(oligo)-glycoside of the formula RO(C₆H₁₀O)ₓ—H in which R represents an alkyl group with 12 to 14 C atoms and x is an average of 1 to 4 is preferably suitable as the oligoglycoside.

PEG-glyceryl stearate must be mentioned as a particularly preferred example of a usable nonionic surfactant. It is commercially available under the name Tagat®.

Moisture retention agents are usually used in dental cosmetics to protect against drying and to control the consistency and cold stability of the products. They can also be used as suspending agents and to influence taste and shine.

Toxicologically unobjectionable polyols such as sorbitol, xylitol, glycerol, mannitol, 1,2-propylene glycol or mixtures of those are usually used as moisture retention agents. Polyethylene glycols with molecular weights of 400-2,000 can also serve as moisture retention components in tooth creams.

A combination of multiple moisture retention components is preferred, with the combination of glycerol and sorbitol containing 1,2-propylene glycol or polyethylene glycol is considered especially preferred.

Depending on the type of product, the complete composition contains the moisture retention agent, or the mixture of moisture retention agents in a proportion of 10-85% by weight, advantageously 15-70% by weight, and particularly 25-50% by weight.

In a preferred embodiment, the materials according to the invention also contain at least one binder or thickener. These act to control the consistency and further inhibit the separation of the liquid and solid ingredients.

They are used in the compositions according to the invention at proportions of 0.1-5% by weight, preferably 0.1-3% by weight, and especially 0.5-2% by weight.

For example, natural and/or synthetic water-soluble polymers such as alginates, carrageenans, agar-agar, guar gum, gum arabic, succinoglycan gum, guar meal, St. John's bread nut meal, tragacanth, karaya gum, xanthan, pectins, cellulose, and their ionic and nonionic derivatives such as carboxymethylcellulose, hydroxyethylcellulose or methylhydroxypropyl cellulose, hydrophobically modified celluloses, starches and starch ethers are used according to the invention.

Water-soluble carboxyvinyl polymers (e.g., Carbopol® types), polyvinyl alcohol, polyvinylpyrrolidone and higher-molecular-weight polyethylene glycols (especially those having molecular weights of 10²-10⁶ Dalton) are also suitable as binders or thickeners. Laminar silicates and finely divided silicic acids (aerogel silicic acids and pyrogenic silicic acids) can also fulfill this function.

In a further preferred embodiment, the oral and dental cleaning material contains other agents active against tooth and gum disease. Those active agents are understood to include, according to the invention, anticaries agents, antimicrobial agents, calculus inhibitors, flavoring materials or an arbitrary combination of those substances.

### Anticaries Agents.

Fluorine compounds, preferably from the group of fluorides or monofluorophosphates in a proportion of 0.1-0.5% by weight, are particularly suitable for combating and preventing caries. Suitable fluorine compounds include, for example, sodium fluoride, potassium fluoride, tin fluoride, disodium monofluorophosphate (Na₂PO₃F), dipotassium monofluorophosphate, or fluoride from an organic amino compound.

### Anti-Plaque Agents.

Preferred preparations according to the invention, especially oral and dental care and cleaning materials, are characterized in that they also contain anti-plaque agents, preferably p-hydroxybenzoic acid methyl, ethyl, or propyl esters, sodium sorbate, sodium benzoate, bromchlorophen, Triclosan, phenylsalicylic acid esters, biguanides such as chlorhexidine, thymol, preferably in proportions of 0.1 to 5% by weight, preferably of 0.25 to 2.5% by weight, and particularly 0.5 to 1.5% by weight, based in each case on the complete material.

### Antimicrobial Agents.

Phenols, resorcinols, bisphenols, salicylanilides and salicylamides, as well as their halogenated derivatives, halogenated carbanilides and p-hydroxybenzoic acid esters are suitable antimicrobial agents.

Of the antimicrobial components, the particularly suitable ones are those that inhibit the growth of plaque bacteria. For example, halogenated diphenyl ethers such as 2,4-dichloro-2′-hydroxydiphenyl ether, 4,4′-dichloro-2′-hydroxydiphenyl ether, 2,4,4′-tribromo-2′-hydroxydiphenylether, and 2,4,4′-trichloro-2′-hydroxydiphenyl ether (Triclosan) are suitable antimicrobial agents. Along with bromchlorphen, bis-biguanides such as chlorhexidine and alexidine, phenylsalicylic acid esters and 5-amino-1,3-bis(2-ethylhexyl)-hexahydro-5-methylpyrimidine (Hexetidine), zinc and copper ions also have antimicrobial action, with synergistic effects occurring, particularly in combination with Hexetidine and Triclosan. Quaternary ammonium compounds such as cetylpyridinium chloride, benzalkonium chloride, domiphen bromide and dequalinium chloride are also usable. Octapinol, octenidine and sanguinarin have also proved to be antimicrobially active.

The antimicrobial agents are used preferably in proportions of 0.01-1% by weight in the materials according to the invention. It is particularly preferred to use Irgacare® MP in a proportion of 0.01-0.3% by weight.

### Calculus Inhibitors.

Calculus is made up of mineral deposits that are very similar to the natural tooth enamel. To inhibit calculus formation, substances that inhibit formation of crystallization nuclei are added to the tooth cleaning substances according to the invention. They inhibit further growth of nuclei that are already present. They include, for instance, condensed phosphates, preferably selected from the group of tripolyphosphates, pyrophosphates, trimetaphosphates or mixtures of them. They are used as their alkali or ammonium salts, preferably as their sodium or potassium salts. Aqueous solutions of these phosphates typically have an alkaline reaction, so that the pH of the dental care materials according to the invention is optionally adjusted to 7.5-9 by addition of acid. Examples of acids that can be used include citric acid, phosphoric acid, or acid salts, such as NaH₂HPO₄. The desired pH of the dental care material can also be adjusted by adding acid salts of the condensed phosphates, such as K₂H₂P₂O₇.

Mixtures of various condensed phosphates and/or hydrated salts of the condensed phosphates are usable according to the invention. Calculus inhibitors are usually used in proportions of 0.1-5% by weight, preferably 0.1-3% by weight, and particularly 0.1-2% by weight in the materials according to the invention.

Organophosphates such as 1-azacycloheptane-2,2-diphosphonate (sodium salt), 1-hydroxyethane-1,1-diphosphonate (sodium salt) and zinc citrate are other suitable calculus inhibitors.

### Agents Against Hypersensitive Teeth.

The materials according to the invention preferably also contain agents against hypersensitive teeth. They are selected from potassium and strontium salts such as potassium chloride, potassium sulfate, potassium bicarbonate, potassium citrate, potassium acetate, potassium nitrate, strontium chloride, strontium nitrate, strontium citrate, strontium acetate, strontium lactate and Eugenol.

Oral and dental care materials can contain Eugenol mixed with aromatic oils. It is preferable for the compositions to contain it in the form of oil of clove bud.

The oral and dental care materials according to the invention preferably contain at least 0.5% by weight of potassium or strontium ions in the form of a dissolved salt and at least 0.01% by weight Eugenol in the pure form or in the form of oil of clove bud.

### Flavoring Materials.

The materials according to the invention preferably contain flavoring materials, including, for example, sweeteners and/or preferably contain flavoring materials, including, for example, sweeteners and/or aromatic oils.

Suitable sweeteners are, for example, saccharinates (especially sodium saccharin), cyclamates (especially sodium cyclamate) and sucrose, lactose, maltose or fructose.

All the natural and synthetic fragrances can be considered as fragrance oils for oral and dental care materials. Natural fragrances can be used both in the form of the ethereal oil (mixture) isolated from the plants as well as in the form of the individual components isolated from the mixture. It is preferred that there be at least one aromatic oil from the group of peppermint oil, curled mint oil, anise oil, Indian anise oil, caraway oil, eucalyptus oil, fennel oil, cinnamon oil, clove oil, geranium oil, sage oil, allspice oil, thyme oil, marjoram oil, basil oil, citrus oil, wintergreen oil, or one or more components of these oils that are isolated from them or produced synthetically. The most important components of the oils named are, for example, menthol, carvone, anethol, cineol, eugenol, cinnamaldehyde, caryophyllene, geraniol, citronellol, linalool, salven, thymol, terpinenes, terpinol, methylchavicol and methyl salicylate. Examples of other suitable fragrances are menthyl acetate, vanillin, ionone, linalyl acetate, rhodinol and piperitone.

Finally, the oral and dental care materials can contain other usual additives to improve the stability and sensory properties. Examples of such additives are:
Vitamins, such as retinol, biotin, tocopherol, ascorbic acid and their derivatives (e.g., esters, salts);
Pigments, such as titanium dioxide or zinc oxide;
Colored pigment particles, such as colored silicic acid particles, such as are in commerce under the tradenames Sorbosil® BFG 51, BFG 52 and BFG 53, or Sorbosil® 2352. Mixtures of differently colored pigment particles can also be used. The materials according to the invention can contain such gel silicic acid particles, colored strongly orange, red or blue, for example, in proportions of 0.1-1.0% by weight.
Bleaches, such as hydrogen peroxide and hydrogen peroxide precursors;
Dyes;
pH-adjusting agents and buffers, such as sodium citrate, sodium bicarbonate or potassium and sodium phosphates;
Preservatives, such as p-hydroxybenzoic acid methyl, ethyl, or propyl ester, sodium sorbate, sodium benzoate, bromchlorophen or Triclosan;
Wound-healing and anti-inflammatory substances such as allantoin, urea, panthenol, azulene or chamomile extract, acetylsalicylic acid derivatives or alkali rhodanides;
Mineral salts such as zinc, magnesium and manganese salts, e.g., sulfates.

The materials according to the invention contain all these optional toothpaste ingredients in proportions of about 2 to 10% by weight, based on the total weight. Preparations to be used according to the invention, preferably oral and dental care agents, especially toothpastes, can also contain substances that reduce the sensitivity of the teeth, such as potassium salts, e.g., potassium nitrate, potassium citrate, potassium chloride, potassium bicarbonate and potassium oxalate. Oral and dental care and cleaning agents preferred according to the invention are characterized by containing substances that reduce the sensitivity of the teeth, preferably potassium salts, especially preferably potassium nitrate and/or potassium citrate and/or potassium chloride and/or potassium bicarbonate and/or potassium oxalate, preferably in proportions of 0.5 to 20% by weight, especially preferably of 1.0 to 15% by weight, further preferably of 2.5 to 10% by weight, and especially of 4.0 to 8.0% by weight, based in each case on the total agent.

Preparations, especially oral and dental care and cleaning agents are further preferred which contain substances reducing the sensitivity of the teeth, preferably potassium salts, especially preferably potassium nitrate and/or potassium citrate and/or potassium chloride and/or potassium bicarbonate and/or potassium oxalate, preferably in proportions of 0.5 to 20% by weight, especially preferably of 1.0 to 15% by weight, further preferably of 2.5 to 10% by weight, and especially of 4.0 to 8.0% by weight, based in each case on the total means.

Oral and dental care and cleaning agents to be used according to the invention are especially preferably characterized by containing 0.2 to 20% by weight, preferably 0.4 to 14% by weight, especially preferably 0.5 to 3% by weight and particularly 0.6 to 2% by weight of at least one bioactive glass.

The oral and dental care and cleaning agents to be used according to the invention, of this embodiment, contain bioactive glass or glass powder or glass ceramic powder or composite materials comprising such a bioactive glass. In the context of the present application ‘glass powder’ is understood to mean also granulations and glass beads.

Because of the requirements for the toxicologic acceptability of the glass and its suitability for consumption, the glass powder must be particularly pure. The heavy metal loading is preferably very slight. For instance, the maximum concentrations in the area of cosmetic formulations are preferably: for Pb<20 ppm, Cd<5 ppm, As<5 ppm, Sb<10 ppm, Hg<1 ppm, Ni<10 ppm.

The unceramized starting glass which is contained directly in the preferred compositions according to the invention, or is optionally used to produce a glass ceramic usable according to the invention contains SiO₂ as the network former, preferably between 35 and 80% by weight. At low concentrations the tendency to spontaneous crystallization increases sharply and the chemical resistance decreases. At high SiO₂ values, the crystallization stability can decrease and the processing temperature becomes distinctly elevated, with poorer hot forming properties. Na₂O is used as a flux to melt the glass. The effect on the melting is bad at concentrations below 5%. Sodium is a component of the phases that form on ceramizing and it must be at correspondingly high concentration in the glass if highly crystalline phases are to be produced by ceramizing. K₂O acts as a flux for melting the glass. Potassium is also released in aqueous systems. If the potassium concentration in the glass is high, potassium-containing phases such as potassium silicates also separate. In silicate glasses, glass ceramics or composites, the chemical resistance of the glass and thus the release of ions into aqueous media, can be adjusted by the P₂O₅ content. In phosphate glasses, P₂O₅ is the network former. The P₂O₅ is preferably between 0 and 80% by weight. To improve the fusibility, the glass can contain up to 25% by weight B₂O₃. Al₂O₃ is used to adjust the chemical resistance of the glass.

The glass ceramic can contain ions with antimicrobial action, such as Ag, Au, I, Ce, Cu, or Zn at concentrations below 5% by weight to increase the antimicrobial, especially the antibacterial, properties of the glass ceramic.

Ions that provide color, such as Mn, Cu, Fe, Cr, Co or V, can be contained individually or in combination, preferably at a total concentration of less than 1% by weight.

The glass or glass ceramic is usually used in powder form. The ceramizing can be accomplished either with a glass block or glass ribbons, or with glass powder. After the ceramizing, the glass ceramic blocks or ribbons must be ground to powder. If the powder was ceramized, is may optionally be reground to remove aggregates formed during the ceramizing step. The grindings can be done dry or in aqueous or nonaqueous grinding media. The particle sizes are usually less than 500 μm. Particle sizes of <100 μm or <20 μm have proven favorable. Particle sizes <10 μm, and less than 5 μm and less than 2 μm are particularly suitable; see below.

The bioactive glasses or glass powders or glass ceramic powders or composite compositions contained in the preferred compositions according to the invention comprise glasses which preferably comprise the following components: SiO₂: 35-80% by weight; Na₂O: 0-35% by weight; P₂O₅: 0-80% by weight; MgO: 0-5% by weight; Ag₂O: 0-0.5% by weight; Agl: 0-0.5% by weight; NaI: 0-5% by weight; TiO₂: 0-5% by weight; K₂O: 0-35% by weight; ZnO: 0-10% by weight; Al₂O₃: 0-25% by weight; and B₂O₃: 0-25% by weight.

Ions such as Fe, Co, Cr, V, Ce, Cu, Mn, Ni, Bi, Sn, Ag, Au, or I, individually or together, in a total of up to 10% by weight, can be added to the basic glass of the composition above to attain other effects such as coloration of UV filtration. A further glass composition can be as follows: SiO₂: 35-80% by weight; Na₂O: 0-35% by weight; P₂O₅: 0-80% by weight; MgO: 0-5% by weight; Ag₂O: 0-0.5% by weight; Agl: 0-0.5% by weight; NaI: 0-5% by weight; TiO₂: 0-5% by weight; K₂O: 0-35% by weight; ZnO: 0-10% by weight; Al₂O₃: 0-25% by weight; B₂O₃: 0-25% by weight; SnO: 0-5% by weight; CeO₂: 0-3% by weight; and Au: 0.001-0.1% by weight.

Especially preferred oral and dental care and cleaning agents are characterized in that the bioactive glass has the following composition, based on its weight:

| | | | | |
|---|---|---|---|---|
| SiO₂ | 35 to 60% by weight | preferably | 40 to 60% | by weight |
| Na₂O | 0 to 35% by weight | preferably | 5 to 30% | by weight |
| K₂O | 0 to 35% by weight | preferably | 0 to 20% | by weight |
| P₂O₅ | 0 to 10% by weight | preferably | 2 to 10% | by weight |
| MgO | 0 to 10% by weight | preferably | 0 to 5% | by weight |
| CaO | 0 to 35% by weight | preferably | 5 to 30% | by weight |
| Al₂O₃ | 0 to 25% by weight | preferably | 0 to 5% | by weight |
| B₂O₃ | 0 to 25% by weight | preferably | 0 to 5% | by weight |
| iO₂ | 0 to 10% by weight | preferably | 0.1 to 5% | by weight |

As already noted above, the bioactive glass is preferably used in particulate form. Here, specially preferred oral and dental care and cleaning agents are characterized in that the particle sizes of the antimicrobial glass are <10 μm, preferably 0.5 to 4 μm to 4 μm, and especially preferably 1 to 2.

Toothpastes containing silicic acid, polishing agents, moisture retention agents, binders and fragrances, which contain 0.00001 to 10, especially 0.01 to 4% by weight, preferably 0.01 to 2% by weight of the composite materials according to the invention of nanoparticulate calcium salts from the group of hydroxyapatite, fluoroapatite and calcium fluoride are a preferred embodiment.

It is desirable, in use of the composite materials according to the invention in products for daily oral and dental care, that the process of remineralization and neomineralization run particularly effectively and rapidly.

The composite materials according to the invention can be applied for coating implants by standard processes of immersion coating or plasma spraying, which are known to those skilled in the art.

The composite materials according to the invention can be combined with other suitable materials such as glycosaminoglycans or proteins for use ad injectable bone replacement materials, and can be formulated with suitable solvents and aids such as a dilute aqueous phosphate buffer.

A further object of the present invention concerns candies containing the sparingly water-soluble calcium salts or composite materials comprising them. Preferably at least 0.000001% by weight of at least one sparingly water-soluble calcium salt or composite materials comprising it are contained.

It is particularly preferable for the candies, particularly those described below, to contain composite materials according to the invention, of a sparingly water-soluble calcium salt according to the invention and a protein component which is preferably selected from collagen, gelatins, casein, and hydrolysates of them, preferably gelatins, especially preferably gelatins of Type A, B or AB, particularly gelatin of the acid bone type.

According to a further preferred embodiment, the candy is selected from the group of confectioneries. Confectioneries are a manifold group of foods which, according to the Guideline for Confectioneries of the Federal Association of the German Confectioneries Industry, mostly have a strong sweet taste due to sugar and/or other common commercial types of sugars, optionally sugar alcohols, sweeteners or other sweet ingredients. Confectioneries are also fillings, glazes or candies, as well as layers, coatings or fillings of confectioneries or fine baked goods. The confectioneries also include sugar-free confectioneries. In these, the sweet taste is produced by sugar alcohols and/or synthetic sweeteners.

Preferred confectioneries include in particular hard and soft caramels, gumdrops, jellies, foamed confectioneries, licorice products, coated tablets, pastilles and candied fruits.

Caramels (also called bonbons) derive their unique nature from boiling down a solution of sugars and/or sugar alcohols. They are made in various forms, using materials that add taste and odor, or which provide colors, and/or which affect the nature, with or without filling. The nature of the caramels ranges from hard caramels, i.e., drops, up to soft caramels. They are distinguished particularly by their residual water content. That can be up to about 5% by weight in hard caramels and up to about 15% by weight in soft caramels. Examples of soft caramels are the elastic chewable gum-like starbursts or the soft, easily chewable, sometimes sticky, toffees. Bonbons differ by the manner of their production, such as cut, pressed, poured and layered bonbons.

Jellies, in the sense of the invention, are soft elastic sugar products with consistency such that they can be bitten (e.g., gelled fruits). Gumdrops such as fruit gums, gummy bears, wine gummies, or gummy pastilles are also sweeteners according to the invention. They are viscoelastic and chewable solids, and are produced just like the jellies from sugars and/or sugar alcohols, gelling agents (such as agar, pectin or gum arabic), gelatins and/or starches (optionally modified). Waxes or vegetable oils can also be used as release agents and glossing agents.

Licorice products are made from a mixture of sugars and/or sugar alcohols, gelatins and/or (also modified) starches and/or flour and/or gelling and thickening agents and various fragrances. Licorice products also contain as a characteristic ingredient at least 3% licorice juice (Succhus liquiritiae; in the usual commercial dry form). Addition of up to 8% by weight, especially up to 2% by weight of sal ammoniac [ammonium chloride] yields strong licorices.

Dragees [coated tablets] consist of a liquid, soft or solid core covered with a smooth or rippled coat made with sugars and/or sugar alcohols, chocolates, and/or other glazes in the sugar-coating process. In the sugar-coating process, for example, a fine spray of a saturated sugar solution is sprayed from a nozzle onto the core, which rotating in a coating pan. Because of the hot air blown in at the same time, the sugar crystallizes and slowly forms many thin layers around the core. If the sugar layer does not contain residual moisture, the candy is called a hard dragee. Soft dragees, on the other hand, can contain some 6 to 12% by weight, especially 8 to 10% by weight residual moisture. Dragees are often given a thin non-sticking and glossing layer. The glossing layer is produced by treatment with wax-like substances, e.g., carnauba wax. In particular, substances influencing the nature, such as starches and colors giving colors, taste and flavor are used.

Pressings or pastilles are produced in the tableting or powder-casting or extrusion process. They optionally contain small amounts of binders and lubricants along with the sugars and/or sugar alcohols.

According to a particularly preferred embodiment, the candy is a hard or soft caramel or a dragee. These sweeteners have the advantage that they are retained in the mouth for a long time and the calcium salt or composite material in the sweet is released only gradually. That particularly promotes and mineralizing and especially the neomineralizing effect.

The active substance can advantageously be incorporated directly in the melt for candies made from melts of sugar and/or sugar alcohols. Surprisingly, the sugar does not crystallize in the melt, giving a polycrystalline mass that is difficult to work when the usual ground apatite is added. The sandy taste that comes with coarse-grained apatite could also not be detected.

The hard caramels, such as bonbons, drops, candy sticks or lollipops, that stay in the mouth for a particularly long time, are particularly preferred. That results in the optimal stepwise release of the calcium salt or composite material according to the invention.

Although some of the ingredients (sugars) damage teeth, consumption of the candy according to the invention results in not only the pleasurable experience but also tooth care and tooth preservation, and furthermore to mineralization of the enamel and/or of the dentine. The tooth care, usually with a toothbrush, tooth paste and/or mouth wash, which has in the past been necessary, but which is not always possible after enjoying sweets, can thus be omitted without damage to the teeth due to the consumption of sweets.

Sorbitol syrup, mannitol, xylitol, lactitol, isomaltitol, maltitol or maltitol syrup are sugar alcohols preferred according to the invention. The substances have the advantage that they have fewer calories per 100 g, and also the degradation of the sugar alcohols to acids by some bacterial of the oral cavity is so slow that they have no cariogenic action. The addition, according to the invention, of composite materials according to the invention to candies containing sugar substitutes results in mineralization of the teeth during and/or after enjoying the sweet, and so contributes particular to maintenance of healthy teeth.

According to another preferred embodiment, the candy according to the invention is filled. Candies with a solid, gel, or liquid core allow, among other things, addition of other taste components in that core. Likewise, active ingredients that cannot be incorporated directly (as by mixing) without reduction or loss of the effect can be added in this manner. Vitamins or alcohol, among other things, can be incorporated in such fillings in bonbons.

It is particularly preferred that the filling contain the calcium salts according to the invention and/or composite materials comprising them. The material according to the invention that is contained in the filling can also be incorporated into sweets in which there is a danger of loss of the effect due to the properties of the candy or its production. This filling can, in particular, be a suspension, a gel or a syrup. In particular, the suspensions or gels can be made with a water base to assure good compatibility. Addition of dispersing or wetting agents suitable for food use can serve to hold the composite materials according to the invention in the suspension. Organic thickeners and their derivatives, in particular, are suitable gel-formers.

Aside from synthetic organic thickeners, natural organic thickeners are particularly suitable. They include in particular agar-agar, carrageenan, tragacanth, gum arabic, alginates, pectins, polyoses, guar meal, St. John's bread nut meal, starches, dextrins, gelatins and casein. Modified natural products are likewise preferred, especially carboxymethylcellulose and other cellulose ethers, hydroxyethylcellulose and hydroxypropylcellulose, as well as nutmeal ethers. Synthetic organic thickeners such as polyethers or inorganic thickeners such as polysilicic acids and/or clay minerals (e.g., montmorillonite, zeolites or silicic acids) can likewise be used according to the invention.

According to a further embodiment of the present invention the candy is a chewing gum.

The chewing gum also promotes flow of saliva because of the chewing motion. The acids that cause caries are diluted and so the health of the oral cavity is supported in a natural manner. Chewing gums that particularly provide tooth care and preservation contain sugar substitutes, especially sugar alcohols.

Chewing gums comprise sugars and/or sugar alcohols, sweeteners, fragrances, other additives providing odor, taste and consistency, dyes, and a water-insoluble chewing mass that becomes plastic on chewing. The chewing gums may also contain release and coating agents (such as talc).

Chewing masses are mixtures of substances providing consistency, i.e., the natural gums, which are solidified saps (exudates) of tropical plants such as chicle, gum arabic, gutta percha, karaya gum, tragacanth, rubber, and the thermoplastic synthetics, butadiene-styrene copolymers, isobutylene-isoprene copolymers, polyethylene, polyisobutylene, polyvinyl esters of the unbranched fatty acids from C₂ to C₁₈ and polyvinyl ethers.

Resins and balsams are used as plasticizers. The natural substances include benzoin, dammar, colophonium, mastic, myrrh, olibanum, peru balsam, sandarac, shellac and tolu balsam. The synthetics include coumarone-indene resin, glycerol-pentaerythritol esters of the resin acids of colophonium and their hydrogenation products.

Paraffins (natural and synthetic) and waxes are used to influence the elasticity. The waxes include those of plant origin such as carnauba wax and those of animal origin such as beeswax or wool wax. There are also mineral waxes such as microcrystalline waxes, as well as chemically modified or synthetic waxes. Emulsifiers (e.g., lecithins or mono- and di-glycerides of acids of cooking fat) and esters such as glyceryl acetate and even glycerin are used as plasticizers.

Vegetable hydrocolloids such as agar-agar, alginic acid and alginates, guar nut meal, St. John's bread nut meal or pectin are added to regulate the consistency of the chewing mass. Fillers, calcium or magnesium carbonates, oxides, such as aluminum oxide, silicic acid and calcium or magnesium silicates, are used to adjust the chewing properties of chewing masses. Stearic acid and its calcium and magnesium salts are used to reduce sticking of the chewing mass to the tooth enamel.

Before the remaining ingredients required to make chewing gum are mixed in, it is necessary to heat the chewing mass, which amounts to about 20-35% (but at least 15%) of the finished chewing gum, to 50-60° C.

According to a particularly preferred embodiment of the present invention, the chewing gum is enveloped by at least one layer, which comprises at least one calcium composite material according to the invention.

The composite materials are simply added to the chewing mass to make chewing gum according to the invention. Alternatively, according to the invention, it is also possible to make a coated chewing gum, with which the enveloping layer contains the two essential ingredients of the product according to the invention. To produce such coated chewing gums according to the invention, the active ingredients, that is, the calcium salt and/or its composite, simply a solution and/or dispersion from which the coating is made, are added and stirred in.

In a preferred embodiment of the present invention the chewing gum according to the invention contains sugar. In connection with the present invention, “sugar” or “sugars” are understood to be products such as sucrose, purified crystalline sucrose, for instance in the form of refined sugar, raffinates, refined white sugar, white sugar or semi-white sugar, aqueous solutions of sucrose, such as in the form of liquid sugar, aqueous solutions of sucrose partially inverted by hydrolysis, such as invert sugar, syrup or invert liquid sugar, glucose syrup, dried glucose syrup, hydrates of dextrose, anhydrous dextrose and other products of starch saccharification, as well as trehalose, trehalulose, tagatose, lactose, maltose, fructose, leucrose, isomaltulose (palatinose), condensed palatinose and hydrated condensed palatinose. Thus the sugar-containing chewing gum according to the invention is characterized in that either the chewing gum itself or the coating layer, or both contains, as sweeteners, sucrose, liquid invert sugar, invert sugar syrup, glucose, glucose syrup, polydextrose, trehalose, trehalulose, tagatose, lactose, maltose, fructose, leucrose, isomaltu lose (palatinose), condensed palatinose and hydrated condensed palatinose or mixtures of those. The sugar-containing chewing gum according to the invention can also contain, aside from the sugar types mentioned above, sugar substitutes, especially sugar alcohols such as lactitol, sorbitol, xylitol, mannitol, maltitol, erythritol, 6-O-α-D-glycopyranosyl-D-sorbitol (1,6-GPS), 1-O-α-D-glucopyranosyl-D-sorbitol (1,1-GPS), 1-O-α-D-glucopyranosyl-D-sorbitol (1,1-GPS), 1-O-α-D-glucopyranosyl-D-mannitol (1,1-GPM), maltitol syrup, sorbitol syrup, fructo-oligosaccharides or mixtures of them, as well as mixtures of sugars and sugar alcohols.

In a further preferred embodiment of the invention the chewing gum according to the invention is a sugar-free chewing gum. In connection with the present invention, a “sugar-free chewing gum” is understood to be a chewing gum in which neither the chewing gum itself nor the coating layer contain as sweeteners any of the sugars named above; that is, neither sucrose, invert liquid sugar, invert sugar syrup, dextrose, glucose syrup, trehalose, trehalulose, tagatose, lactose, maltose, fructose, leucrose, isomaltulose (palatinose), condensed palatinose and hydrated condensed palatinose, or mixtures of them, but instead sugar substitutes. In the preferred embodiment of the invention the sugar-free chewing gum according to the invention is a chewing gum having a maximum content of 0.5% by weight, based on the dry weight, of the sugars mentioned above.

The term “sugar substitute” includes all the substances other than the sugars named above that can be used to sweeten foods. The term “sugar substitute” includes, in particular, substances such as hydrated monosaccharide and disaccharide sugar alcohols, such as lactitol, xylitol, sorbitol, mannitol, maltitol, erythritol, isomaltitol, 1,6-GPS, 1,1-GPS, 1,1-GPM, sorbitol syrup, maltitol syrup, and fructo-oligosaccharides. Thus the sugar-free chewing gums according to the invention are preferably characterized by the fact that neither the chewing gum itself or the coating layer contains as a sweetener lactose, maltose, fructose, leucrose, palatinose, condensed palatinose, hydrated condensed palatinose, fructo-oligosaccharides, lactitol, sorbitol, xylitol, mannitol, maltitol, erythritol, 1,6-GPS, 1,1-GPS, 1,1-GPM, sorbitol syrup, maltitol syrup, or mixtures of them. Sugar alcohols such as sorbitol or sorbitol syrup, mannitol, xylitol, lactitol, maltitol or maltitol syrup, 1,1-GPS, 1,6-GPS, 1,1-GPM or mixtures of them are preferred according to the invention. Sugar alcohols have the advantage that they contain fewer calories per 100 g and that they are not degraded to acids by bacteria of the oral flora, or are degraded only very slowly, so that they have no cariogenic action.

A preferably used mixture of 1,6-GPS and 1,1-GPM is isomalt, in which the 1,6-GPS and 1,1-GPM are present in equimolar or nearly equimolar amounts. 1,6-GPS-enriched mixtures of 1,6-GPS and 1,1-GPM containing 57% by weight to 99% by weight 1,6-GPS and 43% by weight to 1% by weight 1,1-GPM, 1,1-GPM-enriched mixtures of 1,6-GPS and 1,1-GPM having 1% by weight to 43% by weight 1,6-GPS and 57% by weight to 99% by weight 1,1-GPM, and mixtures of 1,6-GPS, 1,1-GPS and 1,1-GPM can be used as sweeteners in the chewing gums, especially sugar-free chewing gums, according to the invention, both in the chewing gum itself and in the enveloping layer. Mixtures of 1,6-GPS and 1,1-GPM enriched with 1,6-GPS and enriched with 1,1-GPM are disclosed in German Patent 195 32 396 C2, and the content of the disclosure in that patent dealing with the description and production of the sweetening mixtures enriched with 1,6-GPS and with 1,1-GPM are completely included in the content of the disclosure of the present teaching. Mixtures of 1,6-GPS and 1,1-GPM are disclosed, for example, in EP 0 625 578 B1, and the content of the disclosure of that patent dealing with the description and production of sweetening mixtures containing 1,1-GPS, 1,6-GPS and 1,1-GPM are completely included in the content of the disclosure of the present teaching.

Another mixture preferred according to the invention which can be used in the chewing gums according to the invention, especially sugar-free chewing gums, is a syrup with a dry content of 60 to 80%, consisting of a mixture of hydrated starch hydrolyzate syrup and isomalt powder or isomalt syrup, in which the dry content of the syrup comprises 7 to 52% (w/w) 1,6-GPS, 24.5 to 52% (w/w) 1,1-GPM, 0 to 52% (w/w) 1,1-GPS, 0 to 1.3% (w/w) sorbitol, 2.8-13.8% (w/w) maltitol, 1.5 to 4.2% (w/w) maltotriitol and 3.0 to 13.5% (w/w) higher polyols. Such a syrup is disclosed in EP 1 194 042 B1, and the content of the disclosure of that patent with respect to the description and production of syrups comprising hydrated starch hydrolysis syrup and isomalt power or isomalt syrup is completely included in the content of the disclosure of the present teaching.

The sugar-free chewing gum according to the invention, which is enveloped with at least one layer comprising the composite material according to the invention can, for instance, be a hard-coated sugar-free chewing gum containing essentially hygroscopic sugar-free sweetener, in which the chewing gum core has a water content of less than 2.5% by weight, based on the weight of the core. The essentially hygroscopic sweetener can, for instance, be sorbitol or hydrated isomaltulose. Such sugar-free hard-coated chewing gums are described in WO 88/08671, and the content of the disclosure of that patent with respect to the description and production of the hard-coated sugar-free chewing gums is completely included in the content of the disclosure of the present teaching.[

Another embodiment of the invention provides that both the sugar-free chewing gum according to the invention and the sugar-free chewing gum according to the invention in the chewing gum itself and/or in the enveloping layer can contain, aside from the sugars and/or sugar substitutes named above, one or more intensive sweeteners. Intensive sweeteners are compounds distinguished by an intense sweet taste with little or negligible nutritional value. It is particularly provided according to the invention that the intensive sweetener used in the chewing gum according to the invention is cyclamate, such as sodium cyclamate, saccharin, such as saccharin sodium, Aspartame®, glycyrrhizin, neohesperidine-dihydrochalcone, thaumatin, monellin, acesulfam, stevioside, altiam, sucralose, or a mixture of those. By using such intensive sweeteners, the proportion of sugars in particular can be reduced and nevertheless the predominantly sweet taste can be maintained.

A further embodiment of the invention; provides that the chewing gum according to the invention has not just one enveloping layer, particularly a sugar-coated layer comprising a sparingly water-soluble calcium salt or composite materials comprising them, but at least up to some hundred such enveloping layers, particularly sugar-coated layers. It is possible according to the invention for the individual layers to contain the same sweetener or the same sweetener. Obviously, it is also possible according to the invention that the individual layers can also comprise different sweeteners. Such sugar-coated chewing gum products are therefore enveloped by layer sequences having different sweetener compositions. By a suitable selection of the sequence and number of the coating steps with the different sweeteners, it is possible to produce intentionally chewing gums with desired properties.

For instance, the chewing gum according to the invention can first be enveloped with 1 to some 45 sugar-coated layers containing the mixture of 1,6-GPS and 1,1-GPM enriched with 1,1-GPM. Then 1 to 45 layers of the mixture of 1,6-GPS and 1,1-GPM enriched with 1,6-GPS are coated on those layers. Such a sugar-coated chewing gum is distinguished by an over-all higher sweetness in comparison with the chewing gums coated with hydrated isomaltulose, for example, because of the higher solubility and greeter sweetening power of the 1,6-GPS-enriched mixture making up the outer coating. Such a sequence of layers is described in German Patent 195 32 396 C2, and the content of the disclosure of that patent with respect to the description and production of chewing gum with that layer sequence is completely included in the content of the disclosure of the present teaching.

The chewing gum according to the invention can, for instance, be a hard-coated chewing gum having the sugar coating comprising multiple layers comprising about 50% to about 100% xylitol and multiple layers comprising about 50% to about 100% isomaltulose. Such chewing gums are disclosed in WO 93/18663, and the content of the disclosure of that patent with respect to the description and production of chewing gums with this layer sequence is completely included in the content of the disclosure of the present teaching.

A further embodiment provides that the individual sugar-coated layers enveloping the chewing gum comprise the same calcium salt and/or the same composite of it. Obviously, it is also possible according to the invention for the individual layers enveloping the chewing gum to comprise different calcium salts and/or different composites thereof. It is also obviously possible for individual layers to contain no calcium salt or no composite of it.

The layer enveloping the chewing gum which comprises the sparingly soluble calcium salt results advantageously in the release of the calcium salt occurring more simply than when the salt is directly incorporated into the chewing gum mass, in which the incorporated calcium salt remains strongly adherent to the sticky matrix of the chewing mass. The layer enveloping the chewing gum dissolves very rapidly on chewing in the mouth. Thus it makes the required amount of active substance available in the mouth, which advantageously assures effective mineralization of the teeth. The addition of the calcium salt and/or composites thereof does not affect the ‘crunch’, i.e., the crunchiness of the chewing gum.

According to a particular embodiment the layer enveloping the chewing gum according to the invention comprises sugars and/or sugar alcohols. The monosaccharide, disaccharide and oligosaccharide sugar types preferred for use in that layer, such as dextrose, fructose and sucrose, glucose syrup, liquid sugar and related products, dried glucose syrup and other starch saccharification products can also be sugar substitutes, especially sugar alcohols.

It is advantageous for the layer comprising the sugars and/or sugar alcohols to dissolve rapidly in the mouth. They can also be applied particularly well to a chewing gum core aside from the sweet taste experience.

Although some of the ingredients (sugars) damage teeth, consumption of the chewing gum according to the invention results not only in the pleasurable experience but also to care and preservation of the teeth, as well as to mineralization of the enamel and/or of the dentine. Therefore it is possible to omit without harm the tooth care (usually with toothbrushes, toothpastes and/or mouthwash) that has previously been needed but is not always possible after eating.

Sorbitol or sorbitol syrup, mannitol, xylitol, lactitol, isomalt, maltitol or maltitol syrup are preferred sugar alcohols according to the invention. These substances have the advantage that they contain fewer calories per hundred grams and furthermore the degradation of the sugar alcohols to acids by some bacteria of the oral cavity occurs so slowly that they have no cariogenic action. The addition, according to the invention, of composites according to the invention to chewing gums comprising sugar substitutes results in mineralization of the teeth during and/or after the enjoyment of the chewing gum, thus contributing to retention of healthy teeth. Because of their physico-chemical properties, the sugar alcohols are particularly suitable for production of thin layers, especially in the pan-coating process. It is particularly preferable to use isomalt in the enveloping layer because this sugar alcohol has a relatively high glass transition temperature, which makes the processing especially easier.

The layer enveloping the chewing gum can be produced in different manners, e.g., by multiple immersion of the chewing gum core in an appropriate solution and/or dispersion.

According to a preferred embodiment of the invention at least one of the layers enveloping the chewing gum is a pan-coated layer. That is, the layer is applied to the chewing gum in the pan-coating process. The pan-coated layer (cover) comprises a smooth or wrinkled [coating] having sugars and/or sugar alcohols, chocolate or other glazings applied around a liquid, soft or solid core by means of the pan-coating process (as described above).

According to another embodiment the chewing gum is a filled chewing gum.

Chewing gums that comprise composite materials according to the invention incorporated into the chewing mass release only trace amounts of the active substance because of their sticky consistency. Biting into the filled chewing gum releases the composite material according to the invention that is contained in the filling directly into the mouth, and so can act better than in the usual chewing gums.

The filled chewing gum can furthermore have at least one layer comprising the composite materials according to the invention enveloping the chewing gum.

According to a further preferred embodiment of the present invention the sweetener comprises a dissolving component. This component or matrix dissolves in the mouth through contact with the saliva. The dissolution can also be accomplished by longer residence time in the mouth (especially more than five minutes) and/or dissolves in the mouth through contact with the saliva. The dissolution can also be accomplished by longer residence time in the mouth (especially more than five minutes) and/or by sucking. The component or matrix here is understood, for instance, to be the sugar matrix or basic mass of a bonbon, a gummy bonbon or also a filling.

It is particularly preferred that the dissolving component or matrix be in the calcium salts and/or composite materials comprising them contained in the candy. That results advantageously in the dissolving component being able to release the active substance in it into the mouth. That is particularly important for those candies with which the active substance is not otherwise released in large amounts.

That can be advantageous, for instance, for a filled chewing gum. The calcium salts and/or composite materials comprising them according to the invention are incorporated into a solid, gel-like or liquid filling that leaves the chewing gum when the gum is bitten in the mouth and releases the active substance. If the filling is liquid, it mixes with the saliva. It is also possible for the calcium salts and/or the composite materials comprising them to be processed, for example, into granulated sugar beads in a chewing gum. It is likewise possible for the materials according to the invention to be applied to the candy as a fine dust, for instance, together with release agents for chewing gums (e.g., talcum) or acidic drops (which are often dusted with powdered sugar, for example, to protect against sticking together).

The active substance in the dissolving component or matrix does not remain adherent in or to a component that does not dissolve, as in the case of incorporation into the chewing mass of a chewing gum. Thus the required amount of active substance that advantageously assures effective mineralization of the teeth is made available in the mouth.

According to a particularly preferred embodiment of the invention, the candy comprises essentially at least one dissolving component or matrix. It is particularly advantageous in this case, according to the invention, that there are no components of the candy that allow the active substance to be bound in the mouth after sucking or dissolving and so not available for mineralization of the tooth material. Appropriate candies can, for instance, be filled or unfilled caramels, gummy bonbons, jellies, foamed sugar products, licorice products, coated tablets or pastilles.

According to a further preferred embodiment the candy contains fragrance substances, sweeteners, fillers and/or other additives (such as glycerol or mineral salts, e.g., Zn²⁺ or Mg²⁺).

Essentially any natural fragrance material or one identical with natural fragrance material, such as fruit fragrances, can be used. They can be contained especially in solid or liquid fruit preparations, fruit extracts or fruit powders. Pineapple, apple, apricot, banana, blackberry, strawberry, grapefruit, blueberry, raspberry, passion fruit, orange, sour cherry, red and black currant, woodruff and lemon are preferred.

Other fragrances, especially aromatic soils such as peppermint oil, curly mint oil, eucalyptus oil, anise oil, fennel oil, caraway oil and synthetic aromatic oils can also be used. That is done particularly preferably in herbal bonbons and cough lozenges as well as in chewing gums.

Other flavoring additives can be, for example: milk, yogurt, cream, butter, honey, malt, caramel, licorice, wine, almond, pistachio, hazelnut or walnut kernels and other high-protein oil seeds and peanuts, coconut, cacao, chocolate, cola or vanilla.

The candy according to the invention can also contain active substances such as menthol and/or vitamins. Organophosphates such as 1-hydroxyethane-1,1-diphosphonic acid, phosphonopropane-1,2,3-tricarboxylic acid (sodium salt) or 1-azacycloheptane-2,2-diphosphonic acid (sodium salt) and/or pyrophosphates, which reduce formation of dental calculus, can also be added.

Sweeteners such as saccharin sodium, acesulfam-K, Aspartame®, sodium cyclamate, stevioside, thaumatin, sucrose, lactose, maltose, fructose or glycyrrhizin are also preferably contained. With those, the proportion of sugar can be reduced and the predominantly sweet taste can still be retained.

All the preservatives allowed for foods can be used as preservatives, such as sorbic or benzoic acids and their derivatives, such as sodium benzoate and para-hydroxybenzoate (sodium salt), sulfur dioxide or sulfurous acid, or sodium or potassium nitrite. Dyes and pigments can also be contained to achieve a pleasing appearance.

A further object of the present invention is use of at least one composite material according to the invention in candies, especially confectioneries, as ingredients with a positive effect on dental health.

In particular, the calcium salts and/or the composite materials comprising them, or the candy containing them, are used for dental care and preservation and also for mineralization of the enamel and/or the dentine. Use of the materials according to the invention can thus counteract dental caries. Aside from the pleasant taste, the candy according to the invention can also be used to prevent caries.

According to a further preferred embodiment, the compositions according to the invention comprise not only the calcium salts and/or the composite materials comprising them according to the invention but also at least one fluoride salt. It has been found, surprisingly, that addition of fluoride results in a synergistic increase of the nucleating effect of the composite materials according to the invention. It is particularly preferable to add sodium and/or potassium fluoride. When the active substances and small amounts of fluoride are added simultaneously, there is a synergistic effect of about five-fold.

According to the invention, proportions of 0.01 to 1.2% by weight, especially 0.1 to 0.90% by weight fluoride salt are preferred, depending on the fluoride salt used (e.g., sodium fluoride). This corresponds to a proportion of 0.05 to 0.15% by weight fluoride ions, and particularly, 0.08 to 0.12% by weight.

According to the invention, proportions of 0.05 to 0.15% by weight, especially 0.08 to 0.12% by weight fluoride are preferred, based on the amount of fluoride ions.

A further object of the present invention is compositions to induce or promote new formation of bone tissue containing calcium salts and/or the composite materials comprising them according to the invention.

It has been found that that test subjects perceive a particularly good, smooth, and clean feeling in the mouth during and after use of the compositions according to the invention, especially in the form of toothpastes.

The following examples are intended to explain the object of the invention in greater detail.

### EXAMPLES

### 1. Production of Composite Materials by Precipitation Reactions in the Presence of the Protein Components

### 1.1 Production of an Apatite-Protein Composite

To produce the apatite-gelatin composite, 2,000 ml of deionized water containing 44.10 g (0.30 mole) CaCl₂.2H₂O (Fisher Chemicals, reagent grade) is placed in a 4-liter beaker thermostatted at 25° C. Separately, 35 g of gelatin (Type AB, DGF-Stoess, Eberbach) is dissolved in 350 ml deionized water at about 50° C. The two solutions are combined and stirred vigorously with a propeller stirrer. The pH is adjusted to 7.0 with dilute aqueous base.

300 mL of a 0.6 M solution of (NH₄)₂HPO₄ solution, previously adjusted to pH 7.0, is added evenly to this solution of gelatin and calcium salt, with vigorous stirring, over a period of 120 minutes, while the pH is held constant at 7.0 by controlled addition of dilute aqueous base. After the addition is complete, the stirring is continued for a further 24 hours.

Then the dispersion is filled into centrifuge cups and the solids are separated from the solution by centrifuging.

The dry composite material contains 43% by weight of organic, i.e., proteinaceous, material. This proportion is determined by ashing the materials for 3 hours at 800° C. or by expert evaluation of a thermogravimetric measurement or by a combustion carbon analysis (CHN) or by a Kjeldahl nitrogen analysis. In each case, the amount of ammonium chloride contaminant must be subtracted.

### 2. Production of Composite Materials by Incorporating Dispersions of Surface-Modified Calcium Salts into Protein Components

### 2.1 Composite Material of Hydroxyapatite and AB Gelatin

Solutions A and B are First Prepared Separately.

Solution A.

25.4 g calcium nitrate tetrahydrate and 8.50 g diammonium hydrogen phosphate are each dissolved in 100 g deionized water. The two solutions are mixed, with formation of a white precipitate. After addition of 10 ml 37% by weight HCl, one gets a clear solution.

Solution B.

200 ml deionized water, 200 ml of a 25% by weight aqueous ammonia solution and 20 g Plantacare® were combined and cooled to 0° C. in an ice bath. Solution A was added to Solution B with vigorous stirring, with formation of a precipitate of hydroxyapatite. After removal of excess ammonia, the dispersion was purified by dialysis. The dispersion is evaporated in a rotary evaporator, with measurement of the amount of water removed, until the proportion of solids in the dispersion, calculated as hydroxyapatite, was 7.5% by weight.

This dispersion was added, at room temperature, to 100 ml of a 10% by weight aqueous solution of AB gelatin (manufacturer: DGF Stoess) made as in Example 1.1. Then the mixture was heated to 80° C. and stirred for 5 minutes at that temperature. Then the product was allowed to solidify at room temperature, producing the composite material.

### 3. Dental Creams with Calcium Salt Composite Materials

| Example | | | | | |
|---|---|---|---|---|---|
| formulation | 4.1 | 4.2 | 4.3 | 4.4 | 4.4 |
| Sident ® 8 | 10.0% by | 10.0% by | 10.0% by | 10.0% by | 10.0% by |
| | weight | weight | weight | weight | weight |
| Sident ® 22S | 7.0% by | 7.0% by | 7.0% by | 7.0% by | 7.0% by |
| | weight | weight | weight | weight | weight |
| Sipernat ® | 0.8% by | 0.8% by | 0.8% by | 0.8% by | 0.8% by |
| 320DS | weight | weight | weight | weight | weight |
| Glycerin | 1.0% by | 0.1% by | 1.0% by | 0.1% by | 0.05% by |
| solution | weight | weight | weight | weight | weight |
| containing 10% | | | | | |
| by weight | | | | | |
| composite | | | | | |
| material | | | | | |
| Polywax ® 1550 | 2.0% by | 2.0% by | 2.0% by | 2.0% by | 2.0% by |
| | weight | weight | weight | weight | weight |
| Texapon ® K | 1.5% by | 1.5% by | 1.5% by | 1.5% by | 1.5% by |
| 1296 | weight | weight | weight | weight | weight |
| Titanium | 1.0% by | 1.0% by | 1.0% by | 1.0% by | 1.0% by |
| dioxide | weight | weight | weight | weight | weight |
| Cekol ® 500 | 1.0% by | 1.0% by | 1.0% by | 1.0% by | 1.0% by |
| T | weight | weight | weight | weight | weight |
| Sodium | 0.33% by | 0.33% by | 0.33% by | 0.33% by | 0.33% by |
| fluoride | weight | weight | weight | weight | weight |
| Sodium | 0.25% by | 0.25% by | 0.25% by | 0.25% by | 0.25% by |
| benzoate | weight | weight | weight | weight | weight |
| Fragrance | 1.0% by | 1.0% by | 1.0% by | 1.0% by | 1.0% by |
| | weight | weight | weight | weight | weight |
| Tagat ® S | 0.2% by | — | — | 0.2% by | 0.2% by |
| | weight | | | weight | weight |
| Saccharin | 0.15% by | 0.15% by | 0.15% by | 0.15% by | 0.15% by |
| sodium | weight | weight | weight | weight | weight |
| Trisodium | 0.10% by | 0.10% by | 0.10% by | 0.10% by | 0.10% by |
| phosphate | weight | weight | weight | weight | weight |
| Sorbitol (70% | 31.0% by | 31.0% by | 31.0% by | 31.0% by | 31.0% by |
| in water) | weight | weight | weight | weight | weight |
| Water | to make 100% | to make 100% | to make 100% | To make 100 | to make 100% |
| | by weight | by weight | by weight | % by weight | by weight |

The following commercial products were used:

Plantacare® 1200: C₁₂-C₁₈-alkyl glycoside
ca. 50% by weight in water
Manufacturer: Cognis
   Sident® 8: Synthetic amorphous silicic acid, BET 60 m²/g
Compacted bulk density: 350 g/L
Manufacturer: DEGUSSA
   Sident® 22 S: Silicic acid hydrogel, BET 140 m²/g
Compacted bulk density: 100 g/L
Manufacturer: DEGUSSA
   Polywax® 1550: Polyethylene glycol, MW: 1550
Softening point 45-50° C.
Manufacturer: RWE/DEA
   Texapon® K 1296: Sodium lauryl sulfate powder
Manufacturer: Cognis
   Cekol® 500 T: Sodium carboxymethyl cellulose
Viscosity (2% in water, Brookfield LVF, 20° C.):
350-700 mPa·s
Supplier: Noviant
   Tagat® S: Polyoxyethylene-(20)-glyceryl monostearate
Manufacturer: Tego Cosmetics (Goldschmidt)

1. A composition comprising sparingly water-soluble calcium salts in the form of individual crystallites or particles having a mean particle diameter of less than 1,000 nm wherein the individual crystallites or particles are platelet-like.

2. The composition of claim 1 wherein the length of the platelet-like crystallites or particles is from 10 to 150 nm and the width is from 5 to 150 nm.

3. The composition of claim 1 wherein the length to width radio of the crystallites or particles is from 1 to 4.

4. The composition of claim 1 wherein the area of the crystallites or particles is from 0.1×10⁻¹⁵ m² to 90×10⁻¹⁵ m².

5. The composition of claim 4 wherein the area is from 1.5×10⁻¹⁵ m² to 15×10⁻¹⁵ m².

6. The composition of claim 1 further comprising a polymer component.

7. The composition of claim 6 wherein the polymer component is selected from the group consisting of proteins, protein hydrolysates and derivatives of protein hydrolysates, polyacrylic acids and polymethacrylic acids.

8. The composition of claim 7 wherein the polymer component is a protein hydrolysate.

9. The composition of claim 8 wherein the protein hydrolysate is selected from the group consisting of polyaspartic acids, alginic acids, pectins, deoxyribonucleic acids and ribonucleic acids.

10. The composition of claim 7 wherein the polymer component is a protein.

11. The composition of claim 10 wherein the proportion of the protein component of the composition is from 0.1 to 80% by weight.

12. The composition of claim 11 wherein the proportion is from 30 to 50% by weight.

13. The composition of claim 1 wherein the sparingly water-soluble calcium salts are made by the process comprising contacting an aqueous solution of a water-soluble calcium salt and an aqueous solution of a water-soluble phosphate and/or fluoride salt at a pH of from 5 and pH 9 to form a precipitate comprising the sparingly water-soluble calcium salts.

14. A method comprising contacting a tooth with an effective amount of a composition of claim 1 whereby the dental enamel of the tooth is hardened or biomineralization is induced or promoted.

15. A method comprising contacting a tooth with an effective amount of a composition of claim 1 whereby the tooth is protected from the physiological, chemical, physical and/or microbiological damage caused by bacterial activity.

16. An oral and dental care composition comprising a composition of claim 1.

17. A method for promoting the formation of new bone tissue comprising contacting bone with an effective amount of a composition of claim 1.
